(19) United States
(12) Patent Application Publication
(10) Pub. No.: US 2021/0323260 A1
(43) Pub. Date: Oct. 21, 2021

(54) Packaging System, Sleeve and Slide Card

(71) Applicant: WestRock MWV, LLC, Atlanta, GA (US)

(72) Inventors: Richard Alan COLLINS, Midlothian, VA (US); Tsugihiko SUZUKI, Henrico, VA (US); Marty JONES, Glen Allen, VA (US)

(21) Appl. No.: 17/359,148

(22) Filed: Jun. 25, 2021

Related U.S. Application Data
(63) Continuation of application No. 16/048,527, filed on Jul. 30, 2018.
Application No. 16/048,527 is a division of application No. 14/768,255, filed on Aug. 17, 2015, now abandoned.
(60) Provisional application No. 61/869,597, filed on Aug. 23, 2013.
(60) Provisional application No. 61/768,318, filed on Feb. 22, 2013.
(60) Provisional application No. 61/768,273, filed on Feb. 22, 2013.
(60) Provisional application No. 61/768,224, filed on Feb. 22, 2013.

(51) Int. Cl. B31B 70/00; B65D 75/32; B65D 5/02; B65D 5/38; B65D 83/04; B31B 70/14; B31B 70/26; B65D 75/36

(52) U.S. Cl. CPC B31B 70/001; B65D 73/0078; B65D 5/0227; B65D 5/38; B65D 83/0463; B31B 70/144; B31B 70/25; B31B 70/26; B31B 70/142; B65D 75/36; B65D 2215/02; B65D 2583/0454; B31B 70/146; B31B 70/252; B65D 75/327

(57) ABSTRACT

A primary package (10; 110; 210; 310;510; 610; 810) for being lockably received in an outer sleeve (700), the primary package comprising a main body panel (12; 112; 212; 312; 512; 612; 812) and a retention tab (14; 114; 214; 314; 512; 612; 812) hingedly connected together along a fold line (17; 117; 217; 317; 517; 617; 817), the retention tab having at least one embossment (18; 118; 218; 318; 518; 618; 818), the fold line having been integrally formed in the primary package.

### REFERENCE TO RELATED APPLICATIONS

This application is a continuation of U.S. patent application Ser. No. 16/048,527, filed on Jul. 30, 2018, which is a Divisional Application of U.S. patent application Ser. No. 14/768,255 filed on Aug. 17, 2015, which is a U.S. National Stage Entry Application of International Application No. PCT/US2014/018008, filed on Feb. 24, 2014, which claims the benefit of priority of U.S. Provisional Application Ser. No. 61/768,224, filed on Feb. 22, 2013; U.S. Provisional Application Ser. No. 61/768,273, filed on Feb. 22, 2013; U.S. Provisional Application Ser. No.61/768,318, filed on Feb. 22, 2013; and U.S. Provisional Application Ser. No. 61/869,597 filed Aug. 23, 2013. All of the above applications are herein incorporated by reference in their entireties.

### FIELD OF THE INVENTION

The present invention relates generally to lockable packaging such as child-resistant, senior-friendly packages for healthcare type applications, sleeve-and-drawer style packages for consumer goods such as food, recreational drugs (for example, tobacco, cigars, cigarettes, etc.), toys, hardware and electrical items or the like and, more specifically but not exclusively, to a lockable slide receptacle (for example, a blister card, a tray, a box, etc.), an outer shell (or sleeve) and to a sleeve-and-drawer style package having an internal slide receptacle, releasably lockable within an outer shell. Typical examples of sleeve-and-drawer packages where the present invention may be employed include, but are not limited to, unit dose packages for pharmaceutical tablets, capsules or lozenges, and security packages to deter package pilferage for small high-value items, such as consumer electronics.

### BACKGROUND OF THE INVENTION

In the field of packaging, particularly in the field of healthcare and medication packaging, it is often required to provide consumers or patients with secure packaging that has child-resistant features to restrict or prevent access to the package contents by a child. At the same time, it is useful for the patient to be able to access their own medication with some degree of ease; as such, it is beneficial if the packaging is also “senior-friendly”. Many packages are available that comprise an inner slide card that holds articles such as medicaments, tablets or vitamins in blisters. The blisters are sealed (often by a foil layer or a polymeric film) to retain product freshness, and are arranged in rows to encourage patients to take the appropriate dose (it being readily visible how many items have been consumed, and how many items are to be consumed). The blisters may be formed directly within the slide card, or a separate blister strip may be attached to a sheet of material to form an inner slide card. The inner slide card, with the blisters of articles, is then slidable inside an outer sleeve. The inner slide card is usually retained and locked inside, the inner slide card providing a locking tail flap that engages the outer sleeve. An unlocking mechanism is usually provided on the outer sleeve to permit the release of the inner slide card. Such unlocking mechanisms often require some dexterity to operate, or require user realisation that co-ordinated operation of more than one feature is required; this may make the package child-resistant.

Further considerations in this technical field are the need for such packages to be re-opened and re-locked many times without failure. A course of medication may, for example, require twenty-one or more doses to be taken over a period of time, and the package must be useable to re-lock and release the blister containing slide card repeatedly without failure. Equally, the cost of providing healthcare products and medication must, as far as possible, be minimised and as such it is desirable to keep the cost of the packaging as low as possible whilst maintaining its durability. Whilst it is also advantageous to provide clearly printed information (such as pill calendars and/or other patient-directed information) on the package, the size of the package is preferably minimised, not only to reduce its production costs by using less material, but also to reduce shipping costs. A lightweight and compact package, with a locking feature that can withstand repeated use, is therefore advantageous.

The present invention seeks to provide an improvement in the field of packaging more specifically but not exclusively, in the field of packaging comprising inner slide cards and outer shells.

A package, or components of a package, of the invention may include means for containing, displaying, locking, unlocking and retaining an internally positioned blister slide card. A package according to the invention may include an opening that allows the insertion and partial extraction of an inner card, and may provide means for positioning the card within the structure such that elements of the inner slide card engage the outer structure to mechanically lock the slide card in place, thereby preventing the slide card (or blister strip) from being pulled or withdrawn from the outer structure. Preferably, a package of the invention provides means in the outer structure for disengaging the mechanical locking features of the outer shell and inner slide card such that the inner slide card can be pulled and/or at least partially extracted from the outer structure. The outer shell may be produced from clear, translucent and/or opaque materials.

### SUMMARY

The present inventions seeks to overcome or at least mitigate the problems of the prior art.

According to a first aspect of the first invention, there is provided a primary package for being lockably received in an outer sleeve, the primary package comprising a main body panel and a retention tab, the retention tab being hingedly connected to the main body panel along a fold line, the retention tab having at least one first embossment, the fold line being an integral formation of the primary package.

Optionally, the fold line is an embossment or debossment within the material forming the primary package.

In some embodiments, the fold line may be co-formed simultaneously with the formation of the at least one first embossment.

In some embodiments, the fold line may define an interface or demarcation between the retention tab and the main body panel.

In some embodiments, the primary package may have first and second opposed sides, the at least one first embossment comprises at least one dummy blister projecting from the first side, and the fold line comprises a channel formed in the second side.

In some embodiments, the primary package may comprise a first side and a second side and wherein a cover sheet is mounted upon the first side and the at least one first embossment projects from the second side, the primary package being folded such that the first side of the retention tab is folded towards the first side of the main body panel.

Optionally, the fold line is shaped and arranged to encourage folding of the first side of the retention tab which is folded towards the first side of the main body panel.

In some embodiments, the at least one first embossment may extend substantially from the fold line.

In some embodiments, the at least one first embossment may terminate at a point at a first distance from the fold line, the first distance being no greater than 2.5 mm. In other embodiments, the first distance is equal to or less than 1 mm.

In some embodiments, the main body may comprise at least one second embossment.

In some embodiments, the primary package may comprise a first side and a second side, and the at least one second embossment comprises at least one dummy blister projecting from the first side of the primary package.

In some embodiments, the at least one second embossment may extend substantially from the fold line.

Optionally, the at least one second embossment terminates at a point at a second distance from the fold line, the second distance being no greater than 2.5 mm.

In other embodiments, the second distance may be equal to or less than 1 mm.

Optionally, the at least one second embossment is co-formed simultaneously with the formation of the fold line and the at least one first embossment.

The primary package may comprise a first side and a second side, and the fold line may comprise a ridge projecting from the first side.

Optionally, the main body comprises an article receiving area.

In some embodiments the article receiving area may comprise one or more cavities for receiving an item.

Optionally, the primary package comprises a cover sheet enclosing an article within said one or more cavities.

According to a second aspect of the first invention, there is provided a packaging system comprising a primary package lockably received in an outer sleeve, the primary package comprising a main body panel and a retention tab, the retention tab being hingedly connected to the main body panel along a fold line, the retention tab having at least one first embossment, the fold line being an integral formation of the primary package, the outer sleeve comprising a tubular structure having a recess defined in one wall, the retention tab forming a latch and the recess forming a keeper.

In some embodiments, the outer sleeve may comprise a release mechanism for releasing the retention tab from the recess.

In some embodiments, the release mechanism may comprise a release button formed in said one wall of the outer sleeve.

According to a third aspect of the first invention, there is provided a method of manufacturing a primary package, as described in the foregoing paragraphs, comprising: moulding at least one embossment in a sheet of material; and simultaneously moulding a fold line in the sheet of material.

According to a fourth aspect of the first invention, there is provided a lockable slide card for being lockably received in an outer sleeve, the lockable slide card comprising a main body panel having an article receiving area and a retention tab connected together along a notional line, the retention tab having at least one first embossment terminating substantially on the notional line and the main body panel having at least one second embossment terminating substantially on the notional line such that a continuous valley is defined between the at least one first embossment and the at least one second embossment to serve as a functional fold line.

According to a fifth aspect of the first invention, there is provided a primary package for being lockably received in an outer sleeve, the primary package comprising a main body panel and a retention tab, the retention tab being hingedly connected to the main body panel along a fold line, the retention tab having at least one first embossment, wherein the fold line is interrupted by one or more gaps to form a plurality of collinear fold lines, the fold lines being an integral formation of the primary package.

In some embodiments, the fold lines may be an embossment or debossment within the material forming the primary package.

In some embodiments, the fold lines may be co-formed simultaneously with the formation of the at least one first embossment.

In some embodiments, the fold lines may define an interface or demarcation between the retention tab and the main body panel.

According to a sixth aspect of the first invention, there is provided a lockable slide card for being lockably received in an outer sleeve, the lockable slide card comprising a main body panel having an article receiving area and a retention tab connected together along a notional line, the retention tab having at least one first embossment terminating substantially on the notional line and the main body panel having at least one second embossment terminating substantially on the notional line such that a continuous valley is defined between the at least one first embossment and the at least one second embossment to serve as a functional fold line.

According to a seventh aspect of the first invention, there is provided a packaging system comprising a lockable slide card lockably received in an outer sleeve, the primary package comprising a main body panel and a retention tab, the retention tab being hingedly connected to the main body panel along a hinge line, the retention tab having at least one first embossment, wherein the hinge line is interrupted by one or more gaps to form a plurality of collinear fold lines, each of the plurality of collinear fold lines being an integral formation of the primary package.

According to an eighth aspect of the first invention, there is provided a primary package for being lockably received in an outer sleeve, the primary package comprising a main body panel having an article receiving area including a plurality of product carrying embossments and a retention tab connected together, the retention tab having a plurality of first embossments and the main body panel having a plurality of second embossments, wherein the plurality of product carrying embossments, the plurality of first embossments and the plurality of second embossments are each arranged in rows, the rows of the plurality of product carrying embossments, the plurality of first embossments and the plurality of second embossments being aligned with one another such that the primary package comprises a plurality of embossment-free regions extending across the main body panel and the retention tab.

In some embodiments, the primary package comprises a hinge line hingedly connecting the retention tab to the main body panel, wherein the fold line is interrupted by one or more gaps to form a plurality of collinear fold lines, the fold lines being an integral formation of the primary package, and wherein each gap in the hinge line is aligned with a respective one of the plurality of embossment free regions.

According to a ninth aspect of the first invention there is provided a packaging system comprising a lockable slide card lockably received in an outer sleeve, the lockable slide card comprising a main body panel having an article receiving area including a plurality of product carrying embossments and a retention tab connected together, the retention tab having a plurality of first embossments and the main body panel having a plurality of second embossments, wherein the plurality of product carrying embossments, the plurality of first embossments and the plurality of second embossments are each arranged in rows, the rows of the plurality of product carrying embossments, the plurality of first embossments and the plurality of second embossments being aligned with one another such that the lockable slide card comprises a plurality of embossment free regions extending across the main body panel and the retention tab.

According to an aspect of the second invention for which protection is sought, there is provided a lockable receptacle for use in a package comprising an outer shell. The lockable receptacle has a first surface and a second surface. The lockable receptacle comprises a main portion having at least one receiving cavity for holding an article, the at least one receiving cavity being formed as a protrusion of the first surface and as an indentation of the second surface. A locking tail flap is hinged to the main portion by a hinge connection; the locking tail flap has an engaging portion shaped and formed such that a maximum width of the locking tail flap proximate to the engaging portion is equal to or greater than the maximum width of the main portion of the lockable receptacle.

According to another aspect of the second invention for which protection is sought, there is provided a lockable receptacle for use in a package comprising an outer shell. The lockable receptacle has a first surface and a second surface. The lockable receptacle comprises a main portion having at least one receiving cavity for holding an article; the at least one receiving cavity is formed as a protrusion of the first surface, and as an indentation of the second surface. A locking tail flap is hinged to the main portion by a hinge connection; the locking tail flap has an edge, a medial portion of which is shaped and arranged for engagement with a locking feature of an outer shell, and has wing portions that are disposed either side of the medial engaging portion.

Optionally, the wing portions are structured and arranged to provide a brace between the side walls of an outer shell to prevent, or at least mitigate against, unfolding of the locking tail flap.

Optionally, a recess is provided between the wing portion and the medial engaging portion of the locking tail flap. Optionally, said recess is trapezoidal in shape.

Additionally, the locking flap comprises a series of formations for adding rigidity to the locking tail flap. , Each formation of the series of formations is formed as a protrusion of the first surface, and as an indentation of the second surface, and one or more of the formations is disposed at an oblique angle relative to the hinge connection, and extends from a location proximate the hinge connection generally towards a corner portion of the free edge of the locking tail flap.

Optionally, one or more of the formations each has a non-uniform height. A first portion of each formation comprises a maximum height, and a second portion of each formation comprises a minimum height. The first portion, comprising the maximum height, is disposed further from said engaging portion than the second portion, comprising the minimum height, is disposed from said engaging portion.

Optionally, two or more integral formations are provided and are arranged substantially in parallel alignment with one another. One or more of said one or more integral formations may have a generally wedge-shaped structure, tapered from the first portion, comprising the maximum height, towards the second portion, comprising the minimum height. Optionally, there may comprise a series of five substantially parallel integral formations. Each of the five integral formations has the same length, the same maximum height and the same angle of taper.

Optionally, there may further comprise two obliquely angled integral formations, one disposed on either side of the series of five substantially parallel integral formations. The two obliquely angled integral formations have a greater length than the length of the integral formations in said series.

According to another aspect of the second invention for which protection is sought, there is provided a package comprising an outer shell and a lockable receptacle. The outer shell has a tubular structure for housing the lockable receptacle defined by four walls and has an open end and a closed end. A composite front wall of the tubular structure has a recess formed internally therein. The lockable receptacle has a first surface and a second surface; the lockable receptacle comprises a main portion having at least one receiving cavity for holding an article. The at least one receiving cavity is formed as a protrusion of the first surface and as an indentation of said second surface. The lockable receptacle comprises a locking tail flap hinged to the main portion by a hinge connection, and is folded with respect to the main portion such that the second surface of the locking tail flap is moved towards the second surface of said main portion. An engaging portion of the locking tail flap is locatable within the recess of the outer shell for locking the lockable receptacle within the outer shell, and the maximum width of the locking tail flap proximate the engaging portion is dimensioned such that it is substantially equal to or slightly less than the internal width of the outer shell and wise. When less than the internal width of the outer shell, it is no more than 2 mm, and preferably no more than 1 mm, smaller than the internal width of the outer shell.

Optionally, the maximum width of the locking tail flap proximate the engaging portion is dimensioned such that it is no more than 5 mm smaller than the internal width of the outer shell.

According to an aspect of the third invention, for which protection is sought, there is provided a lockable receptacle for use in a package comprising an outer shell, the lockable receptacle having a first surface and a second surface and comprises a main portion having at least one receiving cavity for holding an article, the at least one receiving cavity being formed as a protrusion of the first surface and as an indentation of the second surface and a locking tail flap hinged to the main portion by a hinge connection, the locking tail flap comprising: an engaging portion that is engagable with an internal locking mechanism of an outer shell, for locking the lockable receptacle within the outer shell; and comprising one or more formations each formed as a protrusion of the first surface and as an indentation of the second surface and each have a non-uniform height, a first portion of each formation comprises a maximum height, and a second portion of each formation comprises a minimum height, wherein the first portion of maximum height is disposed further from said engaging portion of the locking tail flap than the second portion of minimum height, is disposed from said engaging portion. In other words, the first portion comprising the maximum height is disposed closer to the hinge connection than the second portion comprising the minimum height is disposed to the hinge connection.

Optionally, the one or more formations are integrally formed, optionally by moulding, pressing or thermoforming.

Optionally, two or more integral formations are provided and are arranged substantially in parallel alignment with one another.

Optionally, two or more integral formations are provided and are arranged at about 90° relative to the hinge connection between the locking tail flap and the main portion of the lockable receptacle.

Optionally, one or more integral formations are provided and are arranged at an oblique angle relative to the hinge connection between the locking tail flap and the main portion of the lockable receptacle.

Optionally, one or more of said one or more integral formations has a generally wedge-shaped structure, and is being tapered from the first portion, comprising the maximum height, toward the second portion, comprising the minimum height.

Optionally, the upper surface of the one or more of said one or more integral formations is flat. By flat, it is meant planar or smooth and not stepped.

Optionally, one or more of the one or more integral formations has a triangular cross-sectional shape.

Optionally, one or more of said one or more integral formations has a stepped-shaped structure being tapered from the first portion to the second portion and wherein the upper surface of the one or more of said one or more integral formations comprises two or more upper surface sections. Each of the two or more upper surface sections may be flat, i.e., smooth or planar.

Optionally, a length defined as the distance along the base of an integral formation between an end of the first section and an end of the second section, is between about 0.5 cm and about 2 cm.

Optionally, an angle between an upper surface and a base of an integral formation is between about 5° and about 20°.

Optionally, said one or more integral formations on the locking tail flap all have substantially the same maximum height.

Optionally, the lockable receptacle comprises two or more integral formations and one or more of the two or more integral formations on the locking tail flap has a maximum height that is greater or lower than the maximum height of one or more of the other two or more integral formations.

Optionally, a series of five, substantially parallel, integral formations are provided, each of said five integral formations having the same length, the same maximum height and the same angle of taper.

Additionally, the lockable receptacle comprises two obliquely angled integral formations, one disposed on either side of the series of five substantially parallel integral formations and wherein said two obliquely angled integral formations have a greater length than the length of the integral formations in said series. Optionally, the two obliquely angled integral formations may have a length of about 1.5 cm, whereas the integral formations of the series of five may have a length of about 1.1 cm.

Alternatively, the lockable receptacle comprises two shorter integral formations, one disposed on either side of the series of five substantially parallel integral formations and in parallel alignment therewith, wherein said two shorter integral formations have a lower length than the length of the integral formations in said series. The shorter integral formations may have a length of about 0.5 cm.

According to another aspect of the third invention for which protection is sought, there is provided a package comprising an outer shell and lockable receptacle, the outer shell having a tubular structure defined by four walls, an open end and a closed end for housing the lockable receptacle, a composite front wall of the tubular structure having a recess formed internally therein, the lockable receptacle having a first surface and a second surface, the lockable receptacle comprising a main portion having at least one receiving cavity for holding an article, said at least one receiving cavity being formed as a protrusion of the first surface and as an indentation of the second surface, and the lockable receptacle comprising a locking tail flap hinged to the main portion by a hinge connection, and being folded with respect to the main portion such that the second surface of the locking tail flap is moved towards the second surface of the main portion, an engaging portion of the locking tail flap being locatable within said recess of the outer shell for locking the lockable receptacle within the outer shell, the locking tail flap comprising one or more integral formations, each formed as a protrusion of the first surface and as an indentation of said second surface of the lockable receptacle, said one or more integral formations each having a non-uniform height, a first portion of each integral formation comprising a maximum height and a second portion of each integral formation comprising a minimum height, wherein the first portion is disposed further from said engaging portion of the locking tail flap that is locatable within the recess of the outer shell than the second portion of each formation is disposed from said engaging portion of the locking tail flap.

Within the scope of this application it is envisaged and intended that the various aspects, embodiments, examples, features and alternatives set out in the preceding paragraphs, in the claims and/or in the following description and drawings may be taken independently or in any combination thereof. For example, features described in connection with one embodiment are applicable to all embodiments unless there is incompatibility of features.

### BRIEF DESCRIPTION OF THE DRAWINGS

Exemplary embodiments of the first through third inventions will now be described with reference to the accompanying drawings, in which:

FIG. 1-1 is a plan view from above of a bumpy side of a primary package according to a first embodiment of the first invention;

FIG. 1-2 is a cross section, taken along line A-A in FIG. 1-1, of the rear end portion of the primary package of FIG. 1-1;

FIG. 1-3 is a plan view of a blank for making a sleeve;

FIG. 1-4 is a plan view of the sleeve made from the blank of FIG. 1-4 during a stage of its assembly;

FIGS. 1-5 and 1-6 are perspective views of the sleeve during additional stages of its assembly;

FIG. 1-7 is a perspective view of the assembled sleeve;

FIG. 1-8 is a cross section, taken along line B-B in FIG. 1-7, of a rear end portion of the assembled sleeve, showing the sleeve includes the primary package of FIG. 1-1;

FIG. 1-9 is a cross section, taken along line B-B in FIG. 1-7, of the rear end portion of the assembled sleeve, showing the sleeve including the primary package of FIG. 1-1 to which a pulling force is applied;

FIG. 1-10 is a perspective view from above of the sleeve of FIG. 1-8 and the primary package of FIG. 1-1 in which the primary package has been extracted to a dispensing position;

FIG. 1-11 is a plan view from above of a primary package according to a second embodiment of the first invention;

FIG. 1-12 a plan view from above of a bumpy side of a primary package according to a third embodiment of the first invention;

FIG. 1-13 is a cross section, taken along line C-C in FIG. 1-12, of the rear end portion of the primary package of FIG. 1-12;

FIG. 1-14 is a plan view from above of a bumpy side of a primary package according to a fourth embodiment of the first invention;

FIG. 1-15 is a cross section, taken along line D-D in FIG. 1-14, of the rear end portion of the primary package of FIG. 1-14;

FIG. 1-16 a plan view from above of a primary package according to a further exemplary embodiment of the first invention;

FIG. 1-17 is a cross section of the rear end portion of the sleeve of FIG. 1-7 in which the primary package of FIG. 1-16 is installed;

FIG. 1-18 is a plan view from above of a primary package according to a fifth embodiment of the first invention;

FIG. 1-18A is an enlarged view of the portion within the circle in FIG. 1-18;

FIG. 1-19 is a plan view from above of a primary package according to a fifth embodiment of the first invention illustrating a notional line along which the primary package folds;

FIG. 1-20A is a view taken along the line M-M of the primary package shown in FIG. 1-18;

FIG. 1-20B is a view taken along the line A-A of the primary package shown in FIG. 1-18;

FIG. 1-21 is a side view of the primary package of FIG. 1-12 taken along line CC;

FIG. 1-22 is an enlarged side view of a portion of the primary package of FIG. 1-22 indicated by notional line F;

FIG. 1-23 is a plan view from above of a primary package according to a sixth embodiment of the first invention;

FIG. 1-24 is a plan view from above of a primary package according to a seventh embodiment of the first invention;

FIG. 1-25 is a plan view from above of a sheet of material in which a plurality of primary packages of FIG. 1-23 is formed;

FIG. 1-26A is a schematic plan view from above of the sheet of material of FIG. 1-25 on a processing machine;

FIG. 1-26B is a schematic side view of the sheet of material of FIG. 1-25 on a processing machine;

FIG. 2-1 is a perspective view from above of an open package comprising an outer sleeve and a blister strip according to an embodiment of the invention;

FIG. 2-2 is a plan view from above of a blister strip according to an embodiment of the invention;

FIG. 2-3 is a perspective view from above of the blister strip of FIGS. 2-1 and 2-2 in a flat, open condition;

FIG. 2-4 is a further perspective view from above of the blister strip of FIGS. 2-1 to 2-3 wherein a locking tail flap of the blister strip is folded relative to a main portion of the blister strip;

FIG. 2-5 is yet another perspective view from above of the blister strip of FIGS. 2-1 to 2-4 wherein a locking tail flap of the blister strip is folded relative to a main portion of the blister strip;

FIG. 2-6 is a plan view of the blank for forming the outer shell of FIG. 2-1, which may be used in conjunction with the blister strips of the present disclosure;

FIG. 2-7 is a further perspective view of the outer shell shown in FIG. 2-1, which is formed from the blank of FIG. 2-6;

FIG. 2-8 is a perspective view of a package comprising the outer shell of FIG. 2-7 containing the blister strip of FIGS. 2-1 to 2-4 wherein cross-sectional lines A-A and B-B have been marked thereon;

FIG. 2-9 is a cross-sectional view, taken along the line A-A shown in FIG. 2-8, of a rear end portion of the package of FIG. 2-8;

FIG. 2-10 is a cross-sectional view, taken along the line B-B shown in FIG. 2-8, of a rear end portion of the package of FIG. 2-8;

FIG. 2-11 is a plan view from above of a blister strip according to another embodiment of the disclosure;

FIG. 2-12A is a cut-away view of the outer shell of FIGS. 2-1, 2-6 and 2-7, showing a cross section of the outer shell, slightly in front of the recess;

FIG. 2-12B is a cut-away view of the outer shell of FIG. 2-12A, showing the blister strip of FIG. 2-11 locked in the outer shell;

FIG. 2-13 is a plan view from above of a blister strip according to yet another embodiment of the disclosure;

FIG. 3-1 is a perspective view from above of an open package comprising an outer sleeve and a blister strip (shown with the bumpy side up) according to an embodiment of the third invention;

FIG. 3-2 is a plan view from above of the bumpy side of a blister strip according to an embodiment of the third invention;

FIG. 3-3 is a perspective view from above of the blister strip of FIGS. 3-1 and 3-2 in a flat, open condition;

FIG. 3-4 is a further perspective view from above of the blister strip of FIGS. 3-1 to 3-3 wherein a locking tail flap of the blister strip is folded relative to a main portion of the blister strip;

FIG. 3-5 is yet another perspective view from above of the blister strip of FIGS. 3-1 to 3-4 wherein a locking tail flap of the blister strip is folded relative to a main portion of the blister strip;

FIG. 3-6 is a plan view of blank for forming the outer shell of FIG. 3-1, which may optionally be used in conjunction with the blister strips of the third invention;

FIG. 3-7 is a further perspective view of the outer shell shown in FIG. 3-1, which is formed from the blank of FIG. 3-6;

FIG. 3-8A is a view of the side of the blister strip of FIGS. 3-1 to 3-5 illustrating how the locking tail flap is folded relative to the main part of the blister strip;

FIG. 3-8B is an enlarged perspective view from above of a generally wedge-shaped false blister (also referred to as integral formation);

FIG. 3-9 is a view taken along the line IX-IX of FIG. 3-2, showing a cross section of the rear end portion of the blister strip and particularly showing the generally wedge-shaped false blister formed on the locking tail flap and a false blister on the main portion of the blister strip;

FIG. 3-10 shows a cross section of the rear end portion of the package of FIG. 3-1, wherein the blister strip is disposed in a locked position within the outer shell;

FIG. 3-11A shows a top view of part of a blister strip according to another exemplary embodiment of the third invention; and

FIG. 3-11B shows a perspective view of a false blister according to yet another embodiment of the third invention.

### DETAILED DESCRIPTION OF EXEMPLARY EMBODIMENTS

Detailed descriptions of specific embodiments of the primary package, packaging system, sleeves and method are disclosed herein. It will be understood that the disclosed embodiments are merely examples of the way in which certain aspects of the inventions can be implemented and do not represent an exhaustive list of all of the ways the invention may be embodied. As used herein, the word “exemplary” is used expansively to refer to embodiments that serve as illustrations, specimens, models, or patterns. Indeed, it will be understood that the primary package, packaging system, sleeves and method described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

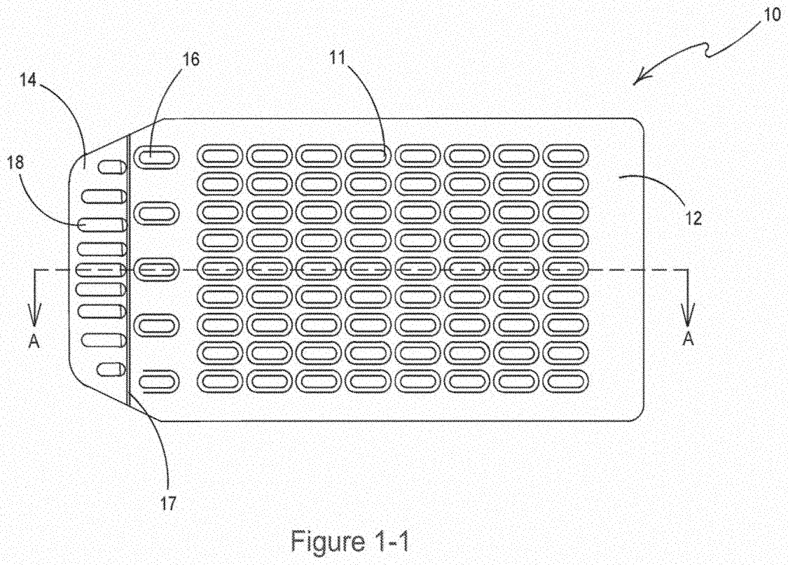

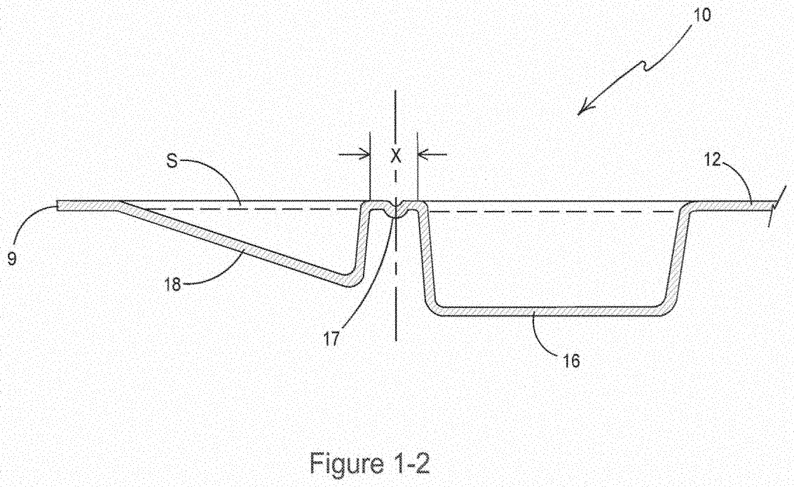

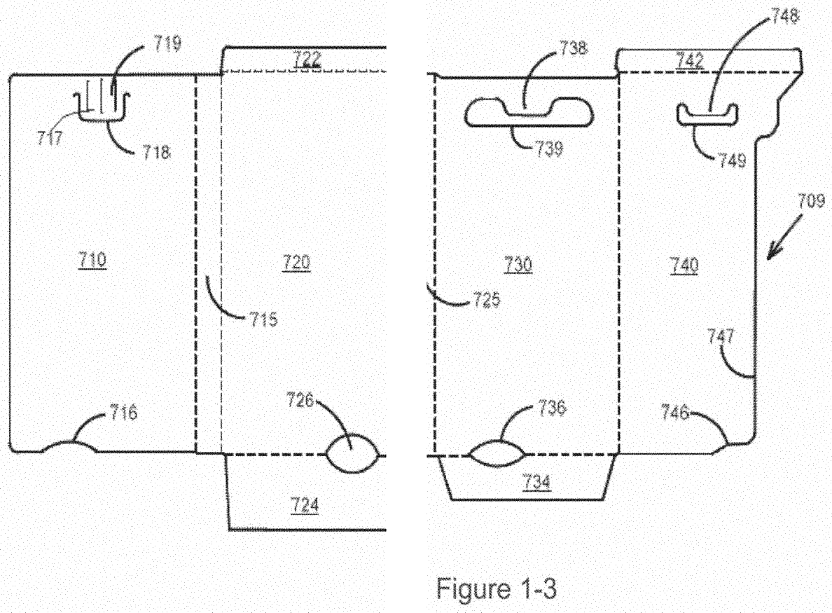

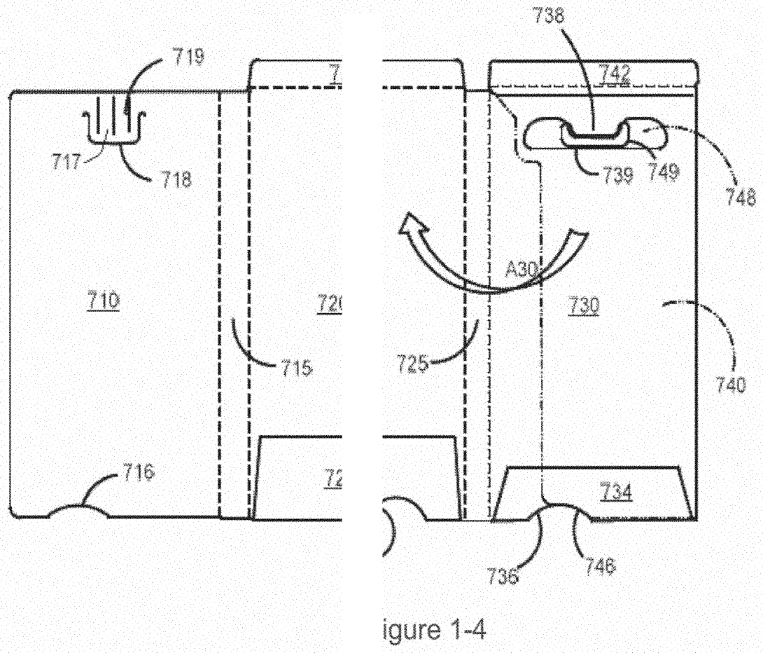

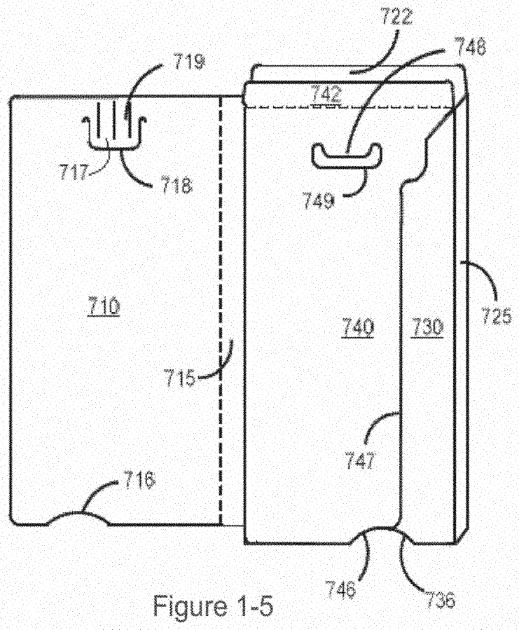

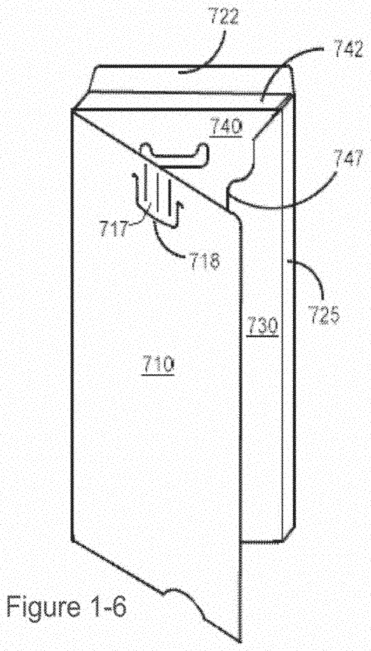

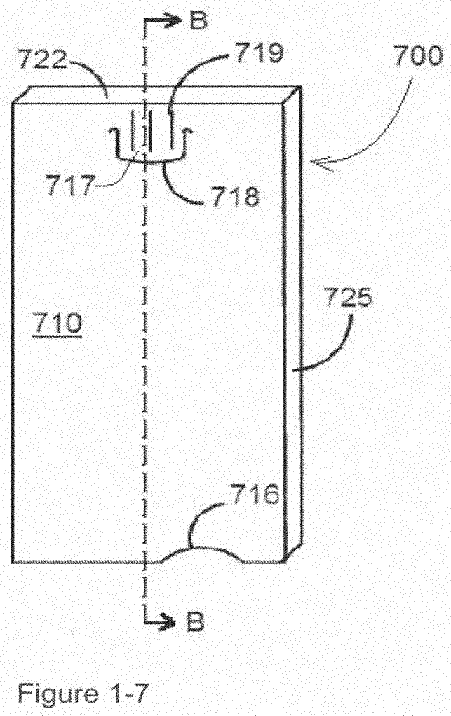

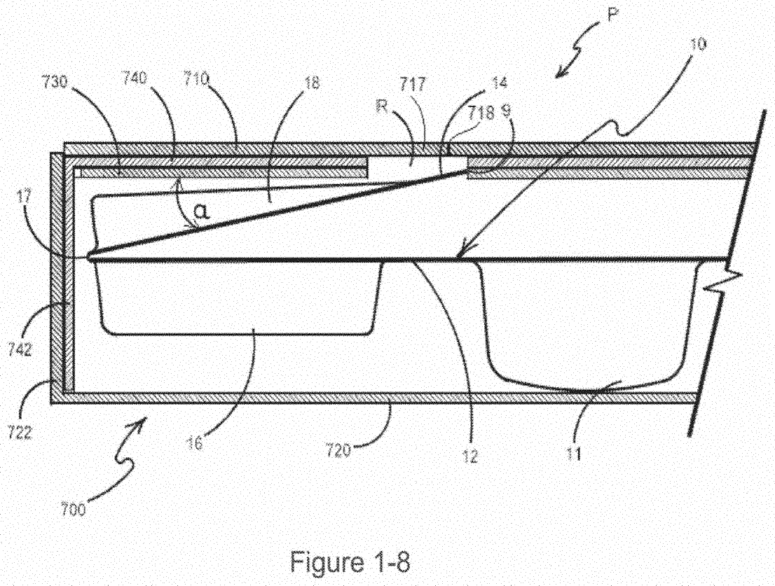

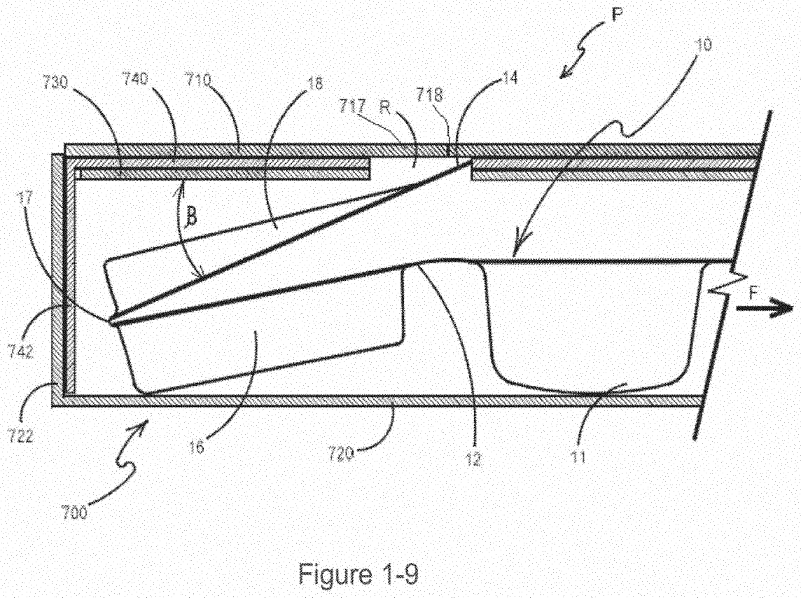

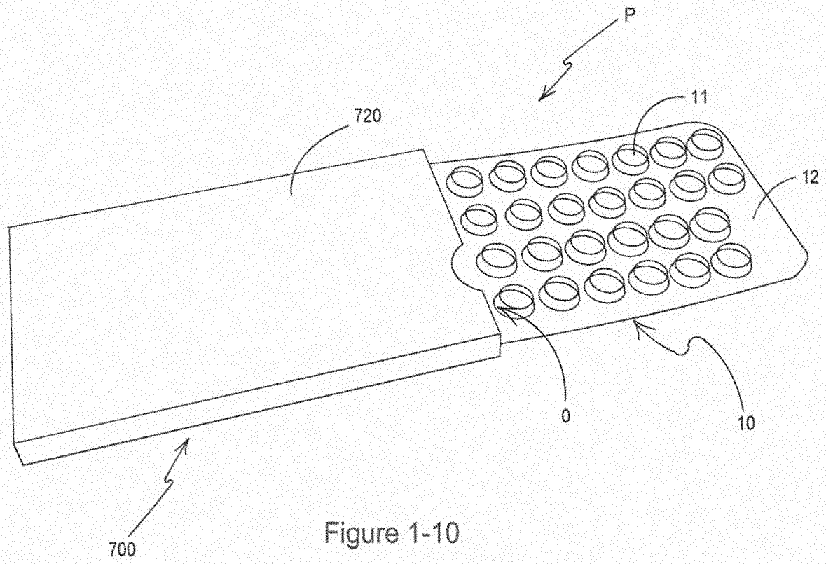

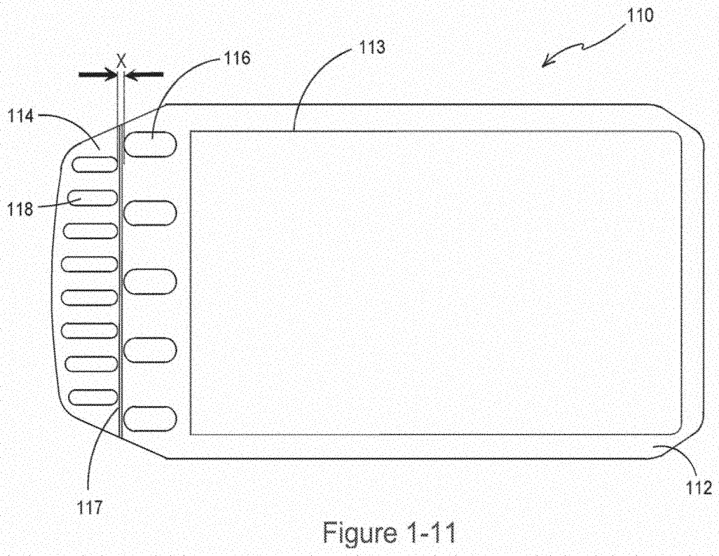

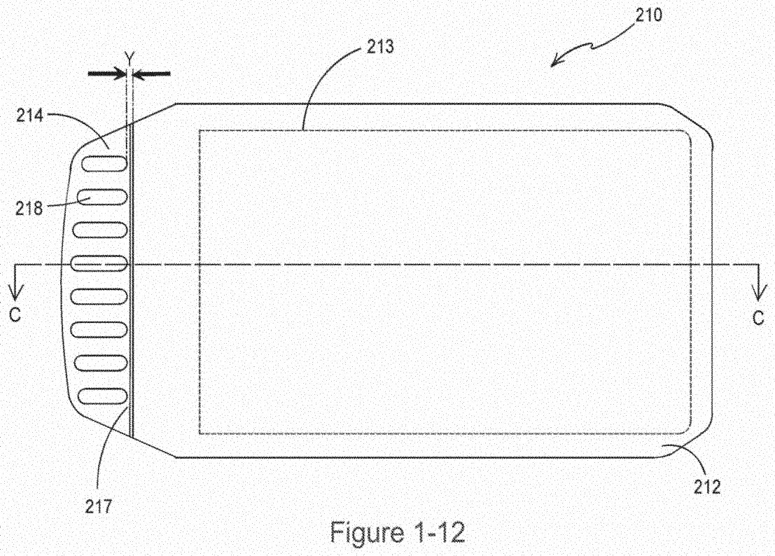

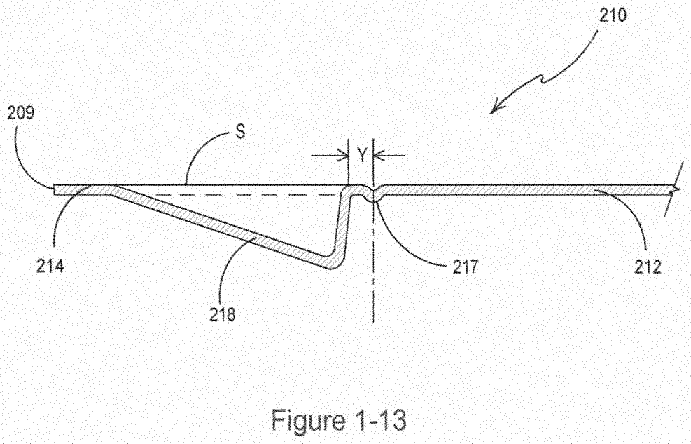

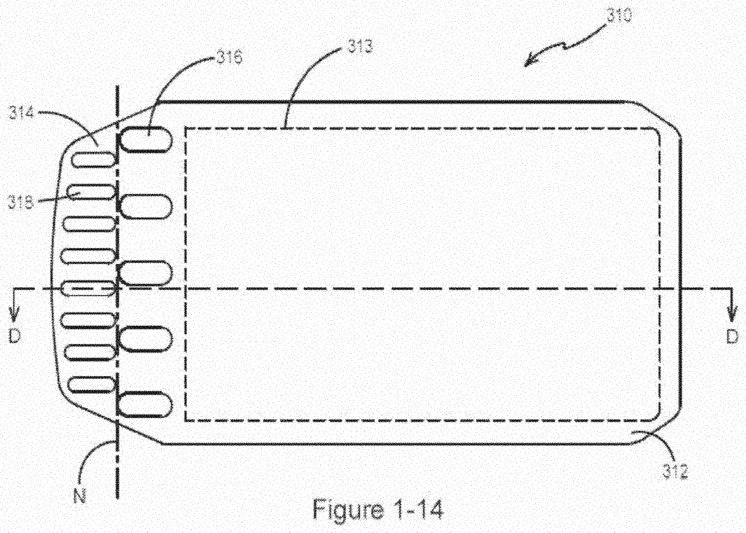

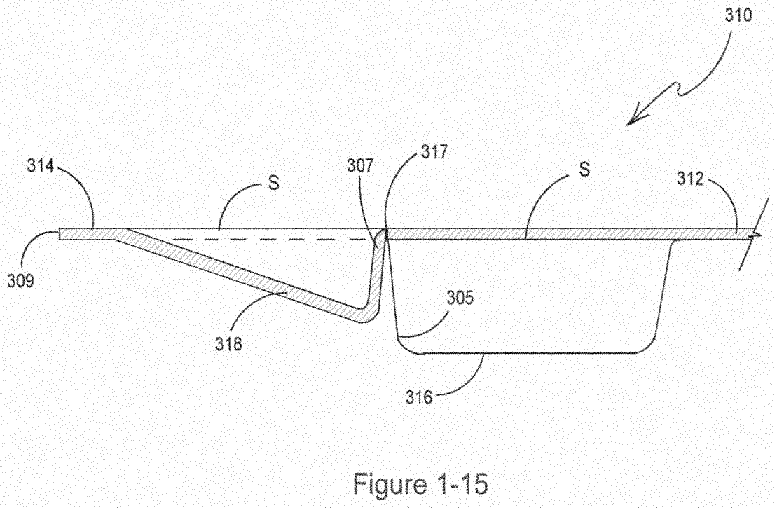

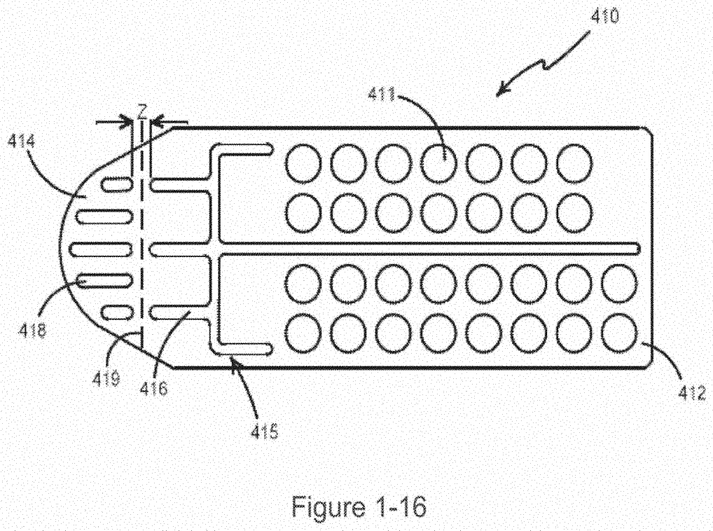

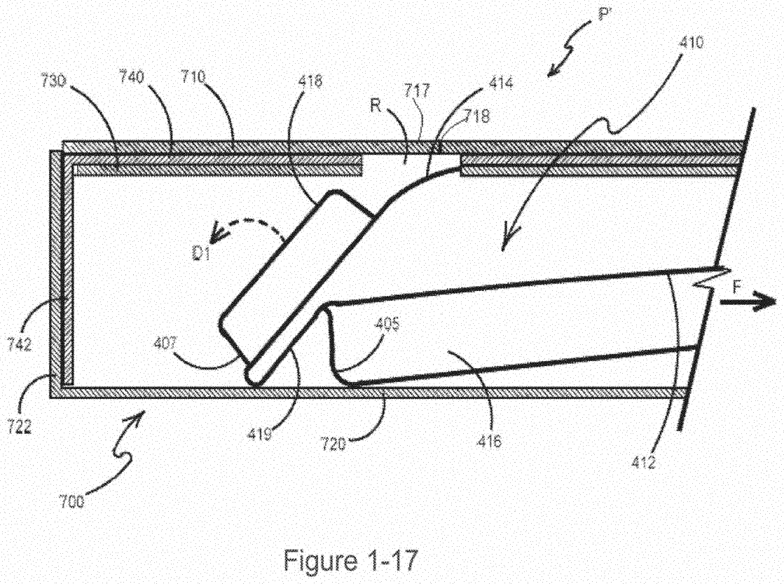

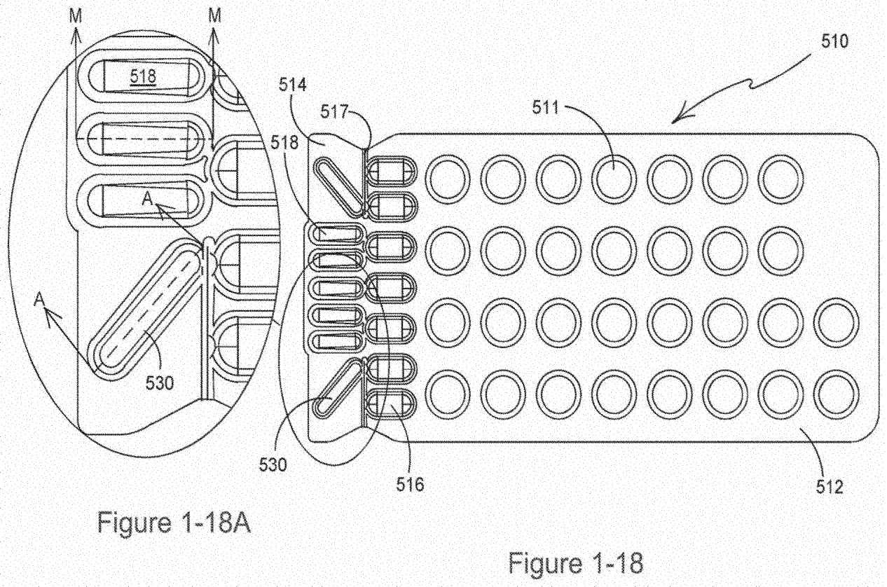

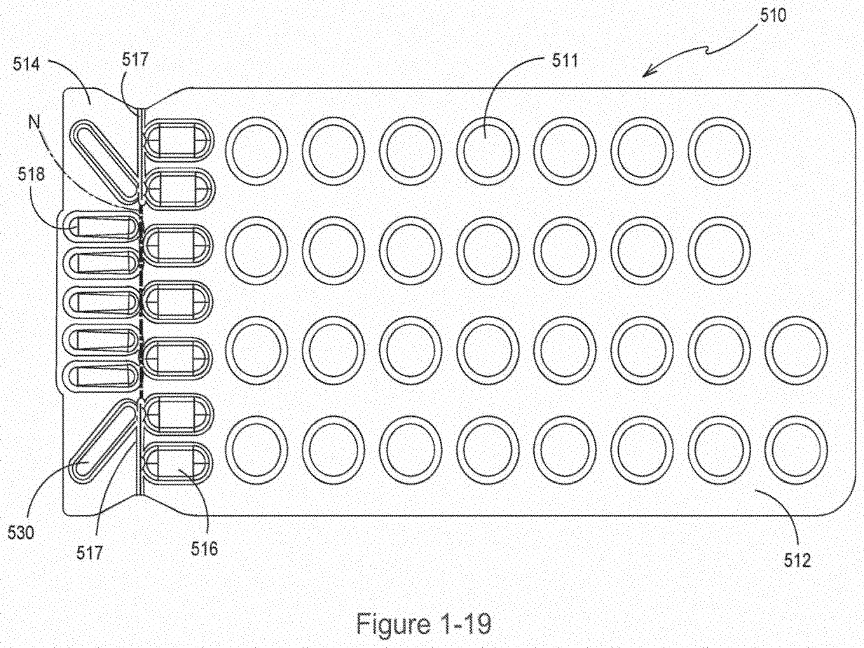

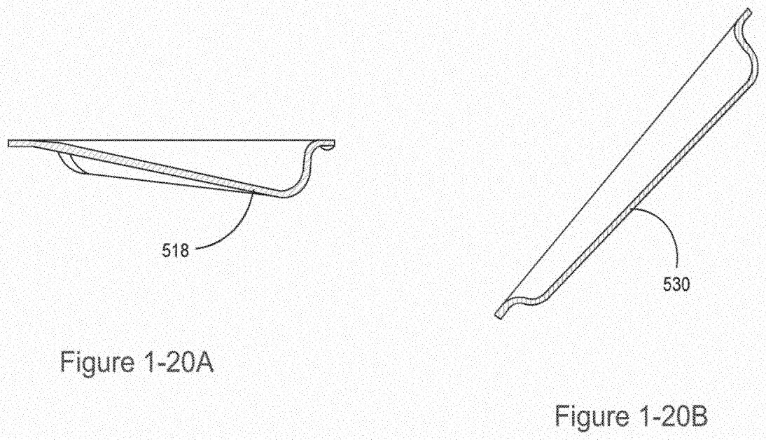

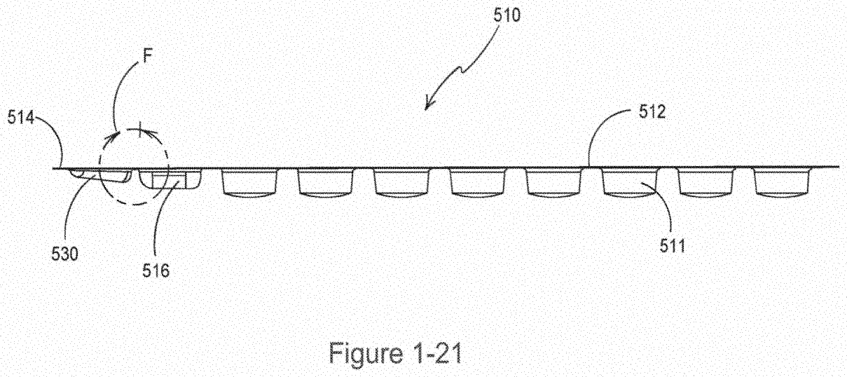

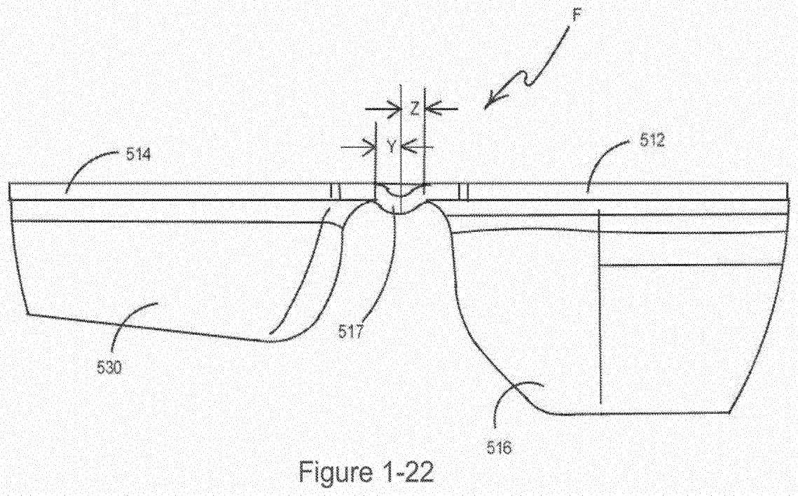

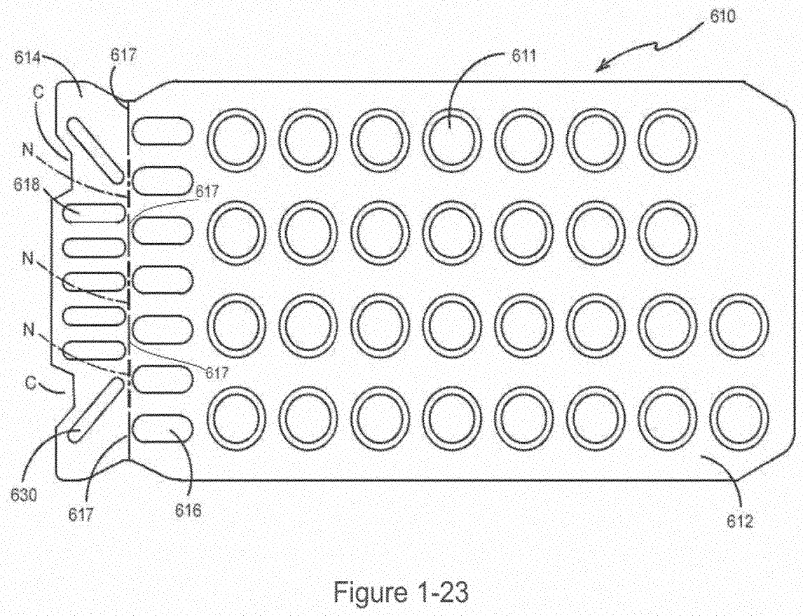

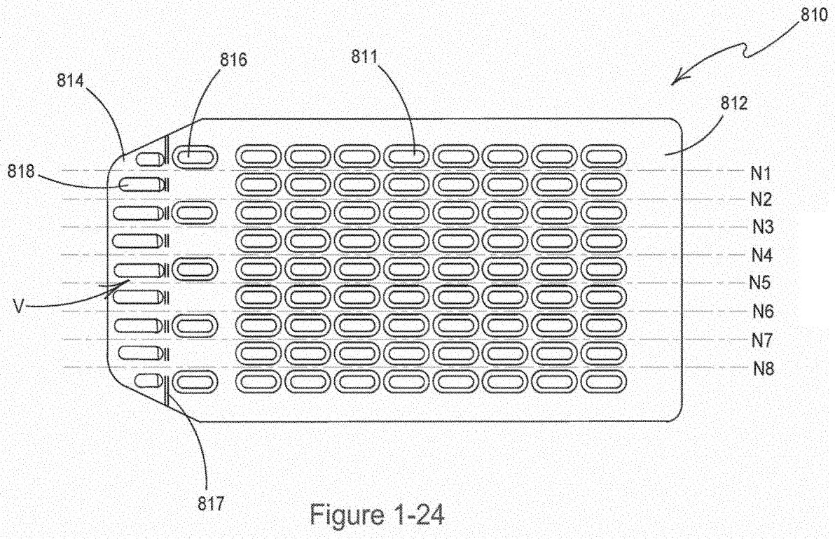

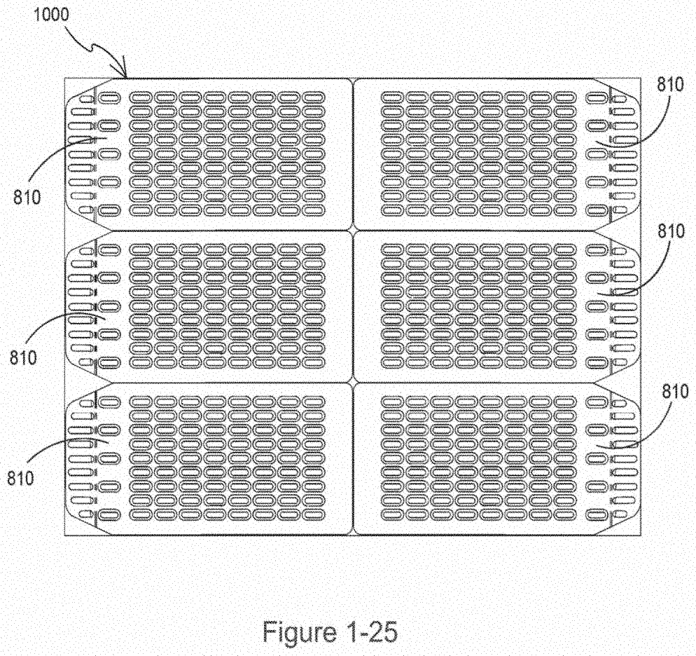

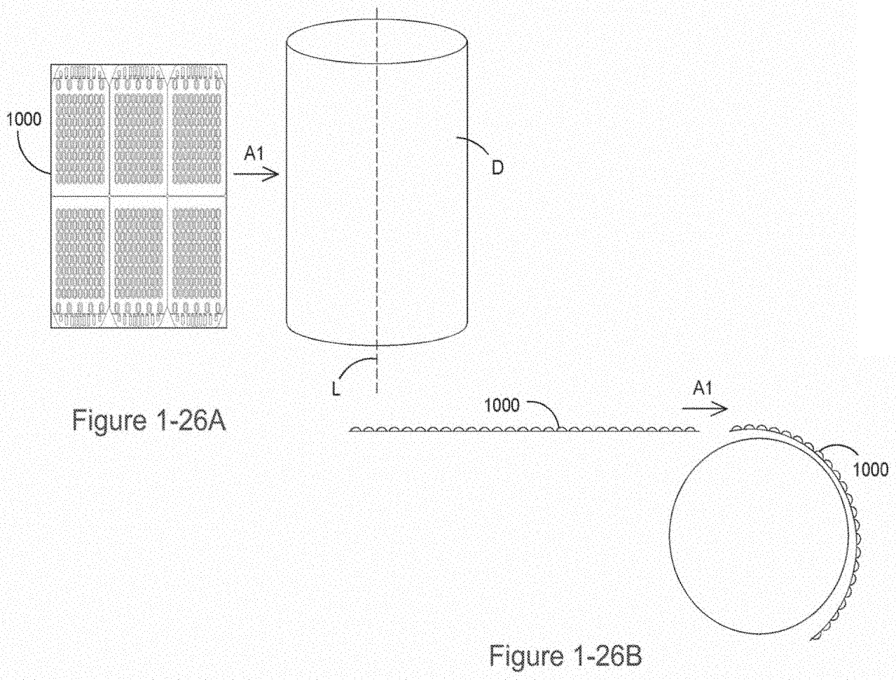

Referring now to FIGS. 1-1 through 1-26B, the first invention is described referring to several embodiments illustrated in those figures.

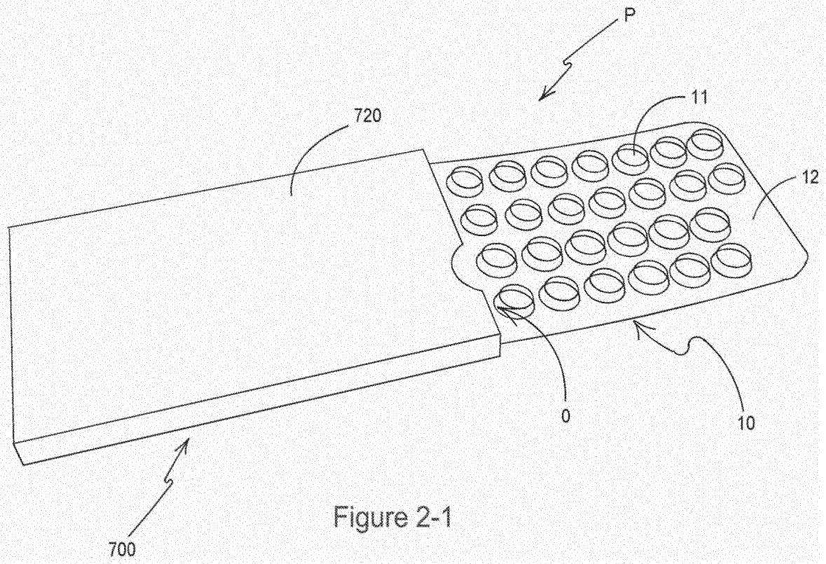

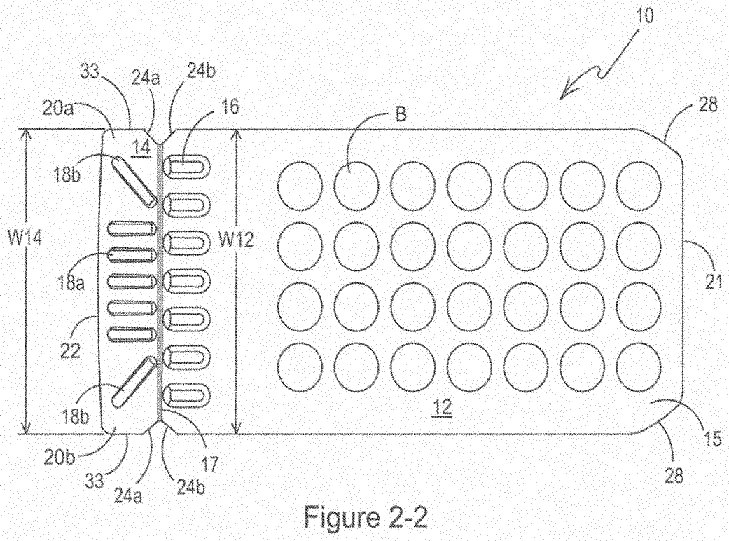

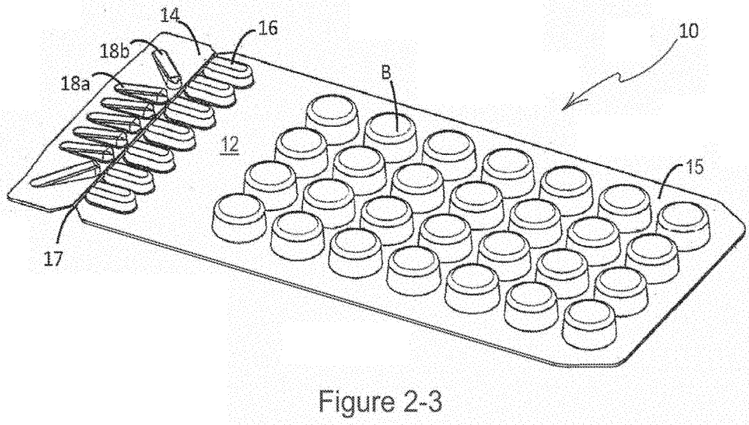

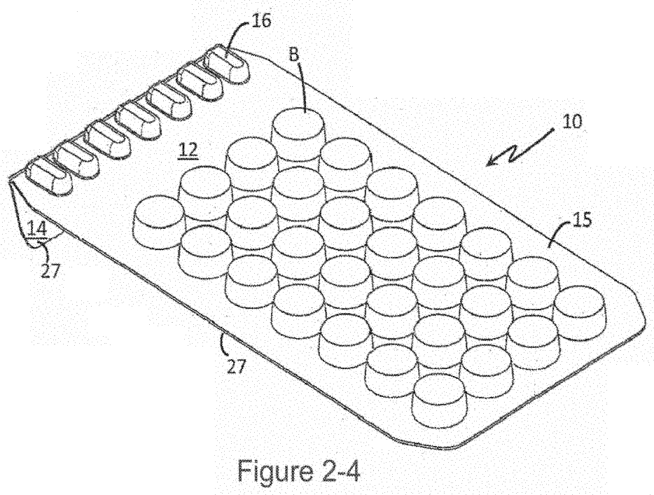

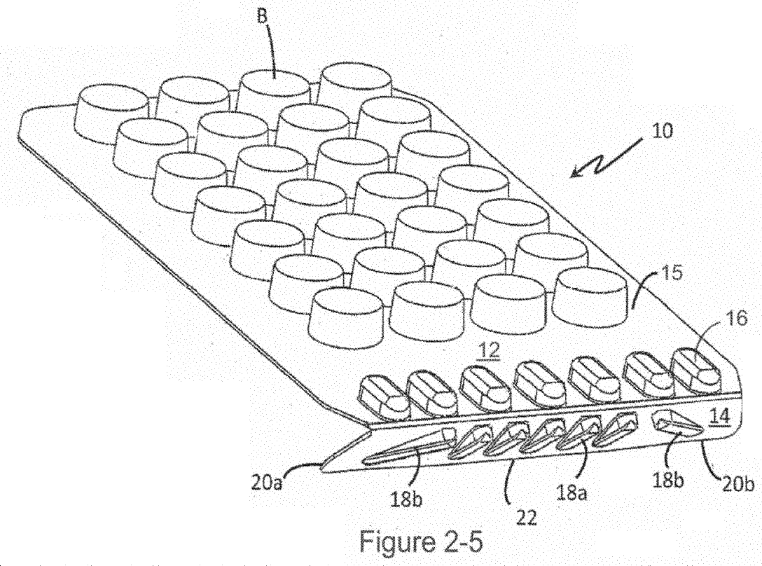

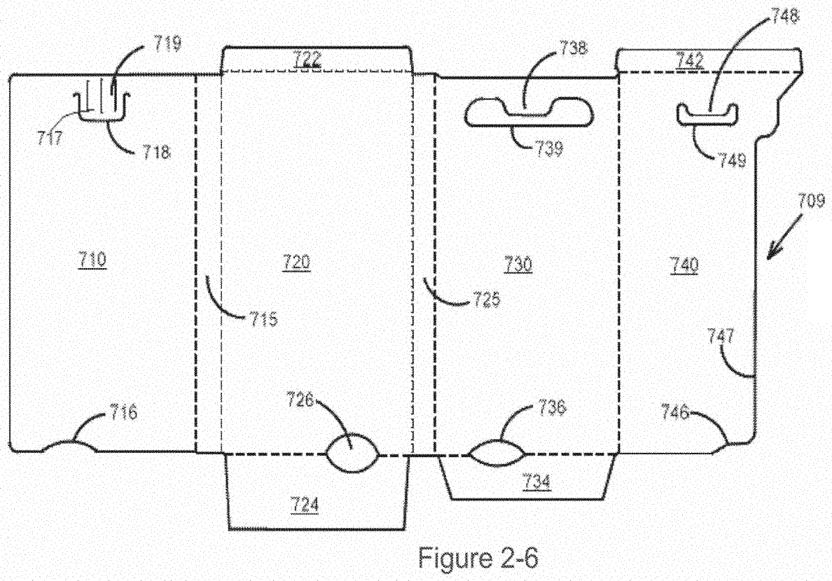

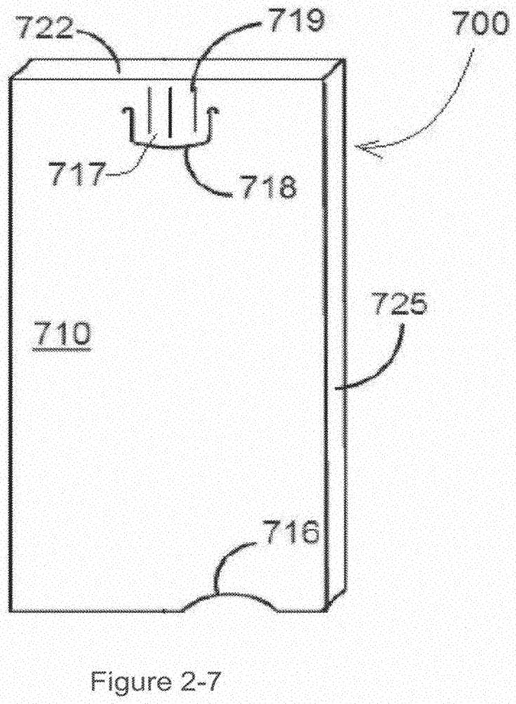

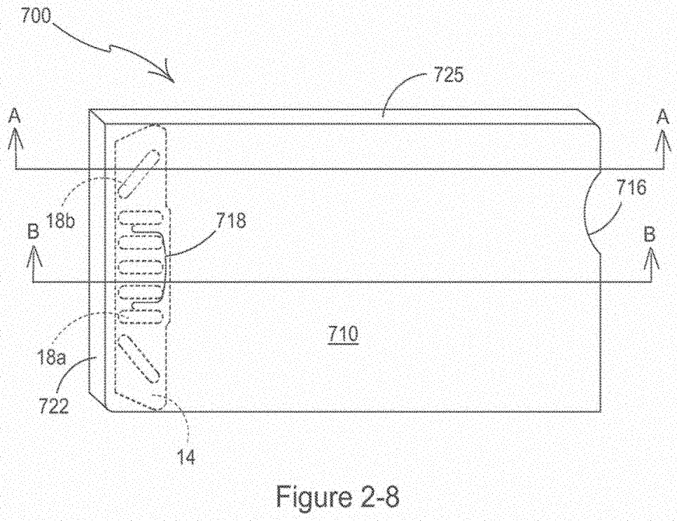

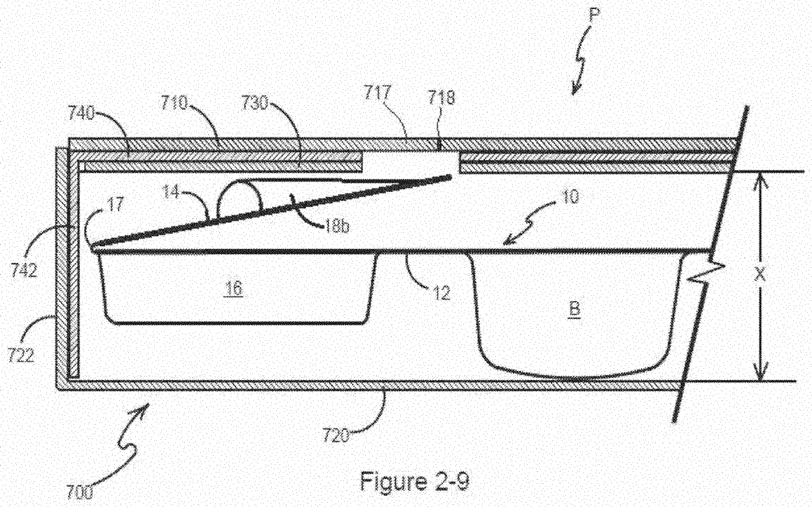

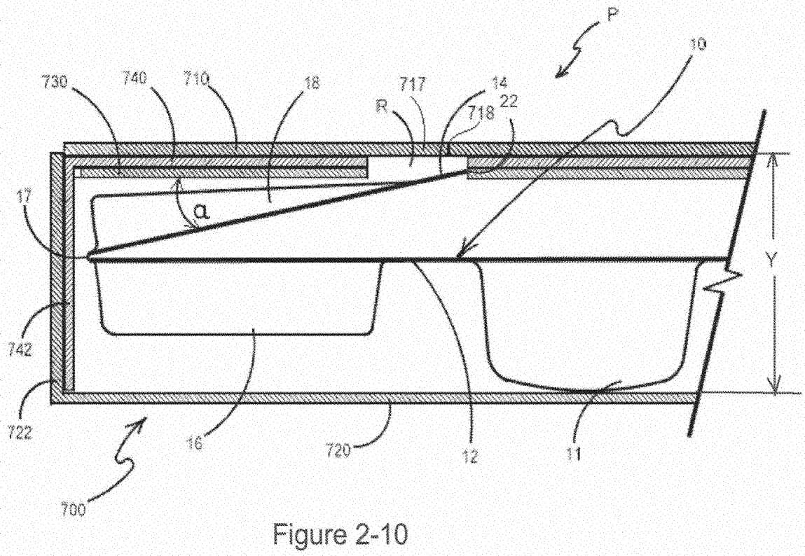

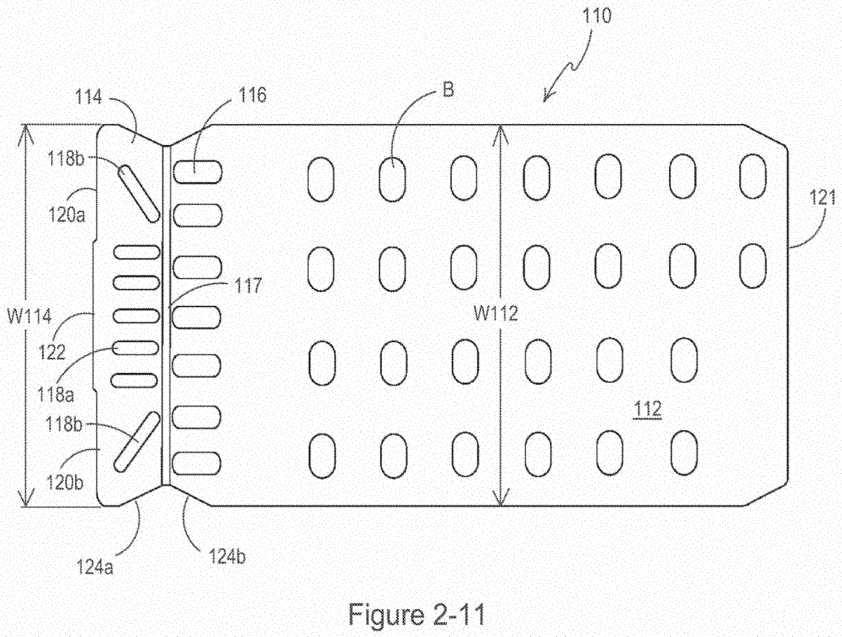

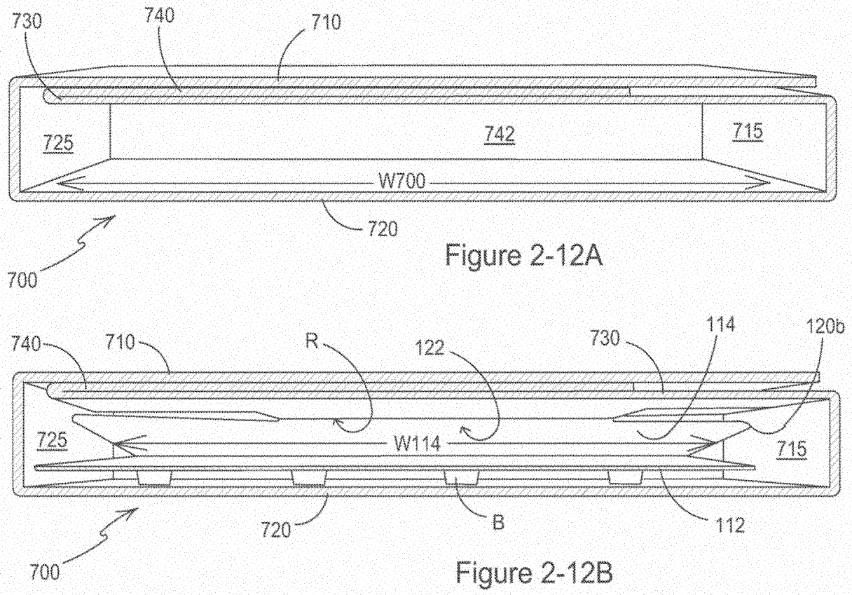

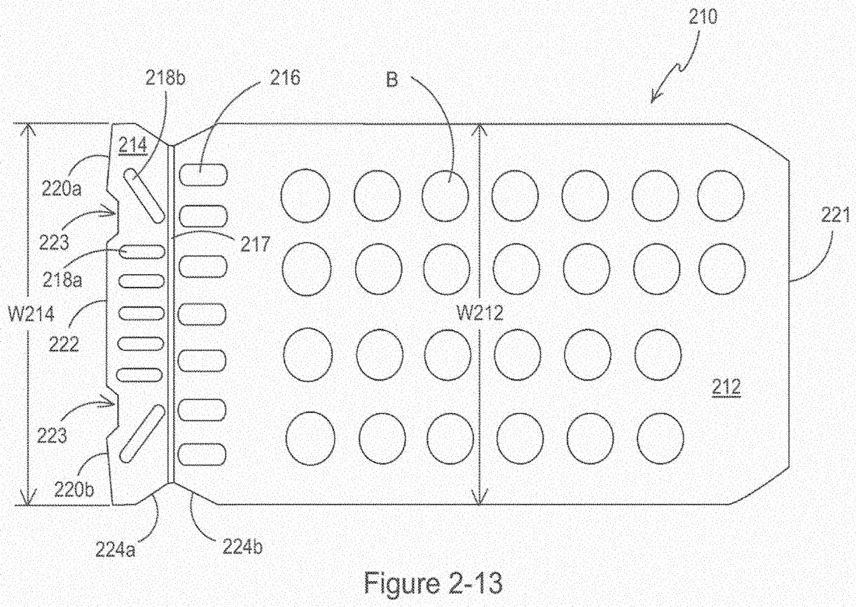

Referring to FIGS. 1-1 and 1-2, there is shown a primary package 10 in the form of a blister card for being received in a sleeve 700 as shown in FIG. 1-7. The primary package 10 is formed from a sheet of material which is moulded or pressed by, for example but not limited to, blow moulding, compression moulding, injection moulding, thermoforming or vacuum forming. The primary package 10 may be formed from a polymer or plastics material or paperboard material. The primary package 10 may comprise one or more coating materials; such coating materials may be employed, for example, for forming a hermetic seal or for adhesion of a cover sheet.

The primary package 10 in the form of an inner slide card or lockable slide card comprises a main body 12 having a plurality of cavities or blisters 11 for receiving an article such as, but not limited to, a medicament. FIG. 1-1 shows the bumpy side of the primary package from which the blisters 11 protrude toward the viewer of that figure. In the illustrated embodiment the primary package 10 is a thermoformed plastic sheet (for example PVC) having nine rows of eight cavities 11, each for receiving an article (not shown). The main body 12 also comprises a first series of empty cavities or false blisters 16 disposed at a first end thereof. The empty cavities 16 may also be referred to as second embossments or dummy blisters.

A retention tab 14, also known as a tail locking flap, is hinged to the first end of the main body 12. The retention tab 14 is employed to lock the primary package 10 within the sleeve 700 in a first position in which it is fully inserted into the sleeve 700, as described in detail below. The retention tab 14 may also be employed to restrict withdrawal of the primary package 10 from the sleeve 700; the retention tab 14 is configured so as to engage with a retention feature provided upon the sleeve 700.

The retention tab 14 comprises a second series of empty cavities or false blisters 18. Optionally, a backing sheet or cover sheet S is applied to an upper surface of the primary package 10 to enclose the blisters 11, 16, 18 such that they are be lidded or sealed. The cover sheet S may be formed from a material such as, but not limited to, aluminium foil sheet, paperboard layer or other perforable or peelable film. Whereas perforable films are often used in pharmaceutical push-through packages where a tablet is pushed out of the blister and this action breaks the backing film to allow that tablet to exit the blister, in other embodiments the backing film may, for example, be peelable and therefore not necessarily of the push-through type. The embodiments described having punch-through backing sheets are for illustrative purposes only and are not limiting.

In other envisaged embodiments, the primary package 10 may be formed of other sheet material, for example other plastics or paperboard. In other arrangements, the primary package 10 may have one or more blisters 11 integrally formed therein, and may only optionally be formed by thermoforming. Alternatively or additionally, the primary package 10 may comprise two parts, a card-type element (not shown) and a blister strip, the blister strip being attached to the card-type element such that the two parts together form a unitary element that is capable of accommodating one or more articles in individual cavities or blisters 11, and that is capable of being withdrawn out of, and pushed by relative sliding movement into, the sleeve 700. The articles to be accommodated by the blisters 11 of the primary package 10 may, for example, be tablets, pills, capsules or for example any other form of medicament, healthcare item, personal item, drug, vitamin, electrical component or other article. The primary package 10 may be capable of holding one or more items or articles. The terms “primary package”, “inner slide card”, “lockable slide card” and “blister strip” are used to refer to components that are placed inside the sleeve 700 and to which the blisters or cavities 11 are attached, or within which the blisters or cavities 11 are integrally formed. The terms “primary package”, “inner slide card” and “blister strip” may be used to refer to components formed of paperboard, plastics material, or combinations of material and such components may be formed from a single piece of material or a composition of different materials.

The retention tab 14 is hinged to the main body 12 by a hinged connection 17 that extends all the way across the width of the retention tab 14 (or that of the main body 12). The hinged connection 17 is integrally formed within the sheet of material forming the main body 12 and retention tab 14, as best illustrated in FIG. 1-2. The hinged connection 17 is a formed score line and is an integral formation within the primary package 10. The sheet of material, from which the retention tab 14 and the main body 12 are both formed, is deformed during the moulding process such that a formed score line having a substantially U-shaped cross section is created. In other embodiments, the score line may take alternative shapes for example, but not limited to, a V-shaped notch; a V-shaped notch which may have a flat base portion between the side walls; or a square notch having a flat base portion and upright side walls.

FIG. 1-2 illustrates a cross section of the rear end portion of the primary package 10. In FIG. 1-2, a first series of empty blisters 16 are disposed at a distance “x” from a second series of empty blisters 18. Optionally, the second series of blisters 18 are substantially triangular or wedge-shaped in cross-section, whereas the first series of blisters 16 are substantially rectangular or trapezoidal in cross-section. In other embodiments the blisters 16, 18 may have alternative shapes. The first series of empty blisters 16 are separated from the second series of blisters 18 by a distance “x”. Optionally, the distance “x” is less than or equal to about 5 mm, and more optionally equal to or less than 2 mm. Each false blister 16, 18 is spaced a distance of about 2.5 mm or less, and optionally about 1 mm or less, from the hinged connection 17.

The primary package 10 is formed by moulding a sheet of material to simultaneously form (or co-form) the blisters 11 for receiving the article, the first and second series of empty blisters 16, 18, and the hinged connection 17. The sheet of material is then cut to shape to form the primary package 10 shown in FIG. 1-1. Optionally, a plurality of primary packages 10 is moulded simultaneously from a single sheet of material and then during the cutting process the plurality of primary packages 10 is cut from the sheet of material. It will be appreciated that the fold line or hinged connection 17 is an integral formation within the material of the primary package 10.

The hinged connection 17 can be formed as a crease or fold line, in the same processing step as forming the empty cavities 16, 18 provided on the retention tab 14 and main body 12. This allows the edge of the cavities 16, 18 to be within one millimetre of the hinged connection 17. The gap or area between the first series of blisters 18 and the second series of blisters 16 can be minimised. This increases the amount of force required to make the primary package 10 fail and pull it out of the sleeve 700 without employing a release mechanism on the sleeve 700, thereby increasing the child resistance of the package. The hinged connection 17 is formed as an embossment or debossment within the material forming the primary package 10. The hinged connection 17 defines an interface or demarcation between the panel forming the retention tab 14 and the panel forming the main body 12.

Another advantage of simultaneously moulding, or otherwise forming, the hinged connection 17 whilst forming the blisters 11, 16, 18 is that a processing stage such as perforating or cold scoring the primary package 10 can be eliminated.

Turning to the construction of a sleeve 700 as illustrated in FIGS. 1-3 to 1-7, it is envisaged that the sleeve 700 can be formed by a series of sequential folding operations in a straight line machine so that the sleeve 700 is not required to be rotated or inverted to complete its construction. The folding process is not limited to that described below and may be altered according to particular manufacturing requirements.

As shown in FIG. 1-3, the blank 709 has a series of foldably attached panels including front panel 710, first side panel 715, back panel 720, second side panel 725, first auxiliary panel 730, and second auxiliary panel 740. The sleeve 700 may receive the primary package 10 and together the sleeve 700 and the primary package 10 form a packaging system P (FIGS. 1-8 and 1-9).

Front panel 710 may include a release button 717 in the form of an area denoted by a cutline 718 which be generally U-shaped. The release button 717 may have score lines 719 to provide stiffness. A cutaway 716 may be provided which may coincide with other cutaways in the finished sleeve 700.

Back panel 720 at one end may be hingedly attached to a first or outer end closure flap 722, whose corners may also be provided with perforations (not shown). Back panel 720 at its opposite end may be provided with an inward facing flap 724 that may be useful for retaining contents within the sleeve. A cutaway 726 may be provided which may coincide with other cutaways in the finished sleeve 700.

The first auxiliary panel 730 at the one end may have an aperture 739 shaped to engage a catch feature such as the edge of retention tab 14 of the primary package 10. Release tongue 738 may extend into the aperture 739 to act along with release button 717 and release tongue 748. At the other end of the first auxiliary panel 730 may be provided an inward facing flap 734 that may be useful for retaining contents within the sleeve 700. Inward facing flap 734 provides a retention feature which engages with the retention tab 14 of the primary package 10 to prevent unintentional separation of the primary package 10 from the sleeve 700. A cutaway 736 may be provided which may coincide with other cutaways in the finished sleeve 700.

The second auxiliary panel 740 at one end may have an aperture 749 also shaped to engage the catch feature. Release tongue 748 may extend into the aperture 749 to act along with release button 717 and release tongue 738. For example the release button 717, release tongue 738, and release tongue 748 may all deflect inwardly when a user applies inward pressure to the release button 717. Second auxiliary panel 740 at this end may be hingedly attached to a second or inner end closure flap 742. At the opposite end, which forms an open end O of the sleeve 700, cutaway 746 may be provided which may coincide with other cutaways in the finished sleeve 700. The distal long end of the second auxiliary panel 740 may be partially cut away as shown by cutaway 747.

In the blank 709 as shown in FIG. 1-3, the upward-facing surfaces may comprise a heat-seal coating which may be located generally on the inside surfaces of the finished sleeve 700. The opposite surface of the blank may have a surface adapted particularly for printing, and may be located generally on the outside of the finished sleeve 700.

The blank shown in FIG. 1-3 may be folded such that the second auxiliary panel 740 is folded backward and behind the first auxiliary panel 730. The auxiliary panels 730, 740 may be attached together for example by glue, hot melt glue, or heat sealable coating. This results in the configuration shown in FIG. 1-4, where the now hidden second auxiliary panel 740 is denoted by phantom lines. The cutaways 736, 746 are seen to coincide along the edge of the structure. Also release tongues 738, 748 generally overlap in this configuration.

The inward facing flaps 724, 734 may now be folded inwardly upon back panel 720 and first auxiliary panel 730, respectively. These flaps 724, 734 may be held in place by the creased fold, or may be glued against their respective panels, or heat sealed thereto.

The structure shown in FIG. 1-4 may be folded as denoted by arrow A30 with the auxiliary panels 730, 740 folded forwards and over back panel 720. This results in the configuration shown in FIG. 1-6, where the back panel 720, second side panel 725, and auxiliary panels 730, 740 make up three walls of a tubular structure. It should be noted that the use of tear resistant materials, and/or more than one layer, help to improve the tamper- and theft-resistance of the package. For example such a coating or treatment may also be on the surface of the substrate that will become the interior of the package. Alternately the inside surface may be left untreated, which might still provide a better sealing surface than some coated surfaces, for example those with coatings optimized for printing, or glossy coatings.

To finish assembling the sleeve 700, as shown in FIG. 1-6, the inner closure flap 742 is first folded downward. The outer closure flap 722 may then be folded upwardly into facing contact with the inner closure flap 742.

After the front panel 710 has been folded up and over secondary auxiliary panel 740, these two panels may be sealed or secured together giving the finished sleeve 700 seen in FIG. 1-7.

Cutaway 747 in second auxiliary panel 740 allows a portion of the inner surface of front panel 710 to seal to a portion of the surface of the first auxiliary panel 730.

As the front panel 710 is secured to both auxiliary panels 730, 740, the front panel 710 in effect has three plies of material at least in part. This stiffens the front panel 710, which may help prevent bowing of the sleeve 700 for example when squeezed transversely by engaging the side panels 715, 725. It will be appreciated that the sleeve 700 comprises a three ply front panel 710, 730, 740 and a single ply back panel 720. As illustrated in FIGS. 1-8 and 1-9 the front panel 710, 730, 740 is disposed uppermost and the back panel 720 is disposed lowermost. In FIG. 1-10 however the front panel 710, 730, 740 is disposed lowermost and the back panel 720 is disposed uppermost.

Turning now to FIG. 1-8, there is shown a cross section, taken along line B-B shown in FIG. 1-7, of the rear end portion of the sleeve 700 including a primary package 10. The primary package 10 is slideably received in the sleeve 700. The retention tab 14 is folded such that the portion of the cover sheet S disposed upon the retention tab 14 is folded towards the portion of the cover sheet S disposed upon the main body 12. In this way the first and second series of blisters 16, 18 are arranged such that the cover sheet S is disposed therebetween. As illustrated the second series of blisters 18 is disposed uppermost facing the three ply front panel 710, 730, 740 and the first series of blisters 16 is disposed lowermost facing the back panel 720. In this way the hinged connection 17 is disposed in close proximity to both the rear wall of the second series of blisters 18 and the front wall of the first series of blisters 16. The free end edge 9 of the retention tab 14 is received within a recess R defined in part by the apertures 739, 749 struck from the first and second auxiliary panels 730, 740. The recess R forms a catch mechanism for locking the primary package 10 within the sleeve 700. The free end edge 9 of the retention tab 14 is in engagement with an edge of the first and/or second auxiliary panels 730, 740 defined by the respective apertures 739, 749. In this way the primary package 10 is locked securely within the sleeve 700. The primary package 10 can be released from the sleeve 700 by pressing upon the release button 717 so as to displace the retention tab 14 out of the recess R. The primary package 10 can then be slid out of the open end “O” of the sleeve 700 as shown in FIG. 1-10. The contents of the blisters 11 can then be dispensed or removed, for example by pressing upon the blisters 11 so as to push the contents through the cover sheet S. In the closed or received position, the retention tab 14 and the front panels 710, 730, 740 define angle a therebetween.

FIG. 1-9 illustrates a cross section, taken along line B-B shown in FIG. 1-7, of the rear end portion of the sleeve 700 including a primary package 10 in which a pulling force is applied, in the direction of arrow F, to the primary package 10, placing the primary package 10 in a state of tension. This may be achieved for example by grasping the main body 12 and pulling in a direction outwardly of the open end “O” of the sleeve 700. The release button 717 has not been depressed to disengage the retention tab 14 from the recess R. This simulates the child-resistant features of the packaging system P in operation. The first series of blisters 16 have been displaced such that the blisters 16 contact the back panel 720; this requires the main body 12 to deform slightly between the first series of empty blisters 16 and the content-holding blisters 11. Bringing the first series of blisters 16 into contact with the back panel 720 prevents the retention tab 14 from unfolding about hinge connection 17 or at least increases the force which would need to be applied in order to unfold the retention tab 14 and thus release the primary package 10 from the sleeve without employing the release mechanism.

It will be appreciated that in other embodiments, the first series of blisters 16 may be dimensioned such that they are substantially in contact with the back panel 720 when in an untensioned or relaxed state, as illustrated in FIG. 1-8.

The retention tab 14 has been displaced such that it is disposed at a greater inclination with respect to the front panel 710, 730, 740; that is to say the retention tab 14 and the front panel 710, 730, 740 define angle β therebetween, the angle β being greater than the angle a shown in FIG. 1-8. This has the effect of directing the free edge 9 of the retention tab 14 further into the recess R, thereby improving the engagement between the retention tab 14 and the recess R.

Referring now to FIGS. 1-11 to 1-15, there are shown alternative embodiments of the present invention. In the second, third and fourth illustrated embodiments, like numerals have, where possible, been used to denote like parts, albeit with the addition of the prefix “100”, “200” or “300” and so on to indicate that these features belong to the second, third or fourth embodiment. The alternative embodiments share many common features with the first embodiment and therefore only the differences from the embodiment illustrated in FIGS. 1-1 to 1-10 will be described in any greater detail.

FIG. 1-11 illustrates a primary package 110 according to a second embodiment of the first invention. The package is shown with its bumpy side facing the viewer of FIG. 1-11. The term “bumpy side” used throughout this application refers to the side of a primary package from which blisters, such as empty blisters 116, 118, protrude. The primary package 110 comprises a main body 112 having an item receiving area 113 for receiving an item to be packaged such as, but not limited to, a syringe or other medical device. The item receiving area 113 may comprise a moulded recess or blister (not shown) which is shaped complementarily to the item. The item may be sealed within the recess by a cover sheet. In alternative embodiments the item receiving area 113 may be substantially flat and the item may be attached to the receiving area by an adhesive. In other embodiments the item may be placed upon the receiving area 113 and a sheet of material or film (not shown) may be applied to the item and the primary package 110 such that the film holds the item upon the primary package 110. In yet other embodiments, the receiving area 113 may comprise one or more mechanical devices or clips either integrally formed therein or secured thereto and the mechanical devices may be used to securely hold the item to the primary package 110. The hinged connection 117 extends entirely across the width of the retention tab 114 (or that of the main body 112). The hinged connection 117 is co-formed with the empty blisters 116 and 118 (and optionally with the item receiving area 113 if the area 113 includes, or by itself is, a moulded portion). The primary package 110 can be employed in combination with the sleeve illustrated in FIGS. 1-3 to 1-7, to form a packaging system.

FIGS. 1-12 and 1-13 illustrate a primary package 210 according to a third embodiment. In FIG. 1-12, the primary package is illustrated with its bumpy side facing the viewer of that figure. The primary package 210 comprises a main body 212 having an item receiving area 213 for receiving an item to be packaged. The primary package 210 comprises a retention tab 214 hinged to the main body 212 by a hinged connection 217. The hinged connection 217 is a formed hinge or score line integrally moulded between the main body 212 and the retention tab 214. The hinged connection 217 extends entirely across the width of the retention tab 214 (or that of the main body 212). The hinged connection 217 is co-formed with the empty blisters 218 (and optionally with the item receiving area 213 if the area 213 includes, or by itself is, a moulded portion). The retention tab 214 comprises a series of empty cavities or blisters 218 which are arranged in a linear series transversely across the retention tab 214. FIG. 1-13 shows a cross section of the rear end portion of the primary package of FIG. 1-12. As shown in FIG. 1-13, the empty blisters 218 are each spaced at a distance “y” from the hinged connection 217. Optionally the distance “y” is less than or equal to about 2.5 mm, and more Optionally less than or equal to about 1 mm. Optionally, the blisters 218 are wedge shaped or tapered such that they are deeper at an end adjacent to the hinged connection 217 than they are at an end adjacent a free end edge 209 of the retention tab 214. The free end edge 209 of the retention tab 214 engages with an edge of the first and/or second auxiliary panel 730, 740 defined by the aperture 739, 749. The primary package 210 can be employed in combination with the sleeve illustrated in FIGS. 1-3 to 1-7, to form a packaging system.

FIGS. 1-14 and 1-15 illustrate a primary package 310 according to a fourth embodiment. In FIG. 1-14, the primary package is shown with its bumpy side facing toward the viewer. The primary package 310 comprises a main body 312 having an item receiving area 313 for receiving an item to be packaged. The primary package 310 comprises a first series of empty blisters 316 arranged in a linear series and spaced apart from one another transversely across the primary package 310. The primary package 310 comprises a second series of empty blisters 318 arranged in a linear series and spaced apart from one another transversely across the primary package 310. The first and second series of blisters 316, 318 are arranged so as to be proximate a notional line N. In some embodiments the blisters 316, 318 of each of the first and second series of blisters 316, 318 are spaced at a distance of 1 mm or less from the notional line N. In another embodiment the blisters 316, 318 of each of the first and second series of blisters 316, 318 are spaced at a distance of 0.5 mm or less from the notional line N. In yet another embodiment the blisters of each of the first and second series of blisters 316, 318 are arranged close to each other such that some or all of the empty blisters 318 on the retention tab 314 terminate on the single notional line N on which some or all of the empty blisters 316 on the main body 312 also terminate. Such an arrangement will allow the retention tab 314 to be folded along the notional line N with respect to the main body 312 when a folding force is applied to the retention tab 314. The notional line N defines a region of the primary package 310 along which it is folded, and as such defines an interface between the retention tab 314 and the main body 312. FIG. 1-15 shows a cross section, taken along line D-D in FIG. 1-14, of the rear end portion of the primary package 310. In the embodiment shown in FIG. 1-15, the front wall 307 of the blister 318 is arranged so as to be inclined with respect to the plane of the main body 312. The rear wall 305 of the blister 316 (it will be appreciated that the blister 316 is offset from the blister 318) is also arranged to be inclined. The front wall 307 of the blister 318 and the rear wall 305 of the blister 316 define an acute angle therebetween. In other embodiments the front wall 307 of the blister 318 may be arranged to be substantially perpendicular to the cover sheet S, and the rear wall 305 of the blister 316 may also be arranged to be substantially perpendicular to the cover sheet S. In some embodiments, at least a portion of the front wall 307 of the blister 318 may be substantially in contact with the rear wall 305 of the blister 316.

In other embodiments each blister 316 of the first series of blisters 316 may be offset in a transverse direction with respect to each blister 318 of the second series of blisters 318. The primary package 310 can be employed in combination with the sleeve illustrated in FIGS. 1-3 to 7, to form a packaging system.

Referring now to FIGS. 1-16 and 1-17, there is shown an example of a primary package 410. In the example, like numerals have, where possible, been used to denote like parts, albeit with the addition of the prefix “400” to indicate that these features belong to the example. The example shares many common features with the first to fourth embodiments of the present invention and therefore only the differences from the embodiments illustrated in FIGS. 1-1 to 1-15 will be described in any greater detail.

FIG. 1-16 illustrates a plan view of an example of a primary package 410 in which a main body 412 is hinged to retention tab 414 by a hinged connection 419. Hinged connection 419 is created by perforating the material forming the primary package 410 with a knife or other suitable tool. In other examples the hinged connection 419 may be created by cold scoring the primary package 410.

The processing step of perforating or cold scoring the primary package 410 is performed separately to the processing step of forming the empty blisters 416, 418 and, when present, the content-holding blisters 411. These methods require that the empty cavities or blisters 416, 418, that are disposed on one or both sides of the hinged connection 419, are disposed further away from the hinged connection 419 than the false blisters 16, 18; 116, 118; 218; 316, 318 are spaced from the hinged connection 17; 117; 217; 317 in the foregoing embodiments, in which foregoing embodiments the hinged connection 17; 117; 217; 317 is integrally formed during the moulding processing step.

The first series of empty blisters 416 is disposed at a distance “z” from the second series of blisters 418. The distance “z” is greater than the distance “x”, for example the distance “z” is greater than 5 mm, with each of the first and second series of blisters 416, 418 being disposed more than 2.5 mm from the hinged connection 419. The increase in space between the first and second series of blisters 416, 418 allows for manufacturing tolerances when using the two stage manufacturing process. However, this additional space can weaken the primary package 410 and reduces the pull-out force F, thus reducing the strength of the child resistant features of the packaging system P′.

The primary package 410 also includes a reinforcing structure 415, formed as a unitary empty blister. The reinforcing structure 415 is unitary with the first series of empty blisters 416 which are disposed adjacent to the hinged connection 419. An elongate portion of the reinforcing structure 415 extends longitudinally across the main body 412. Optionally, the elongate portion is disposed centrally within the main body 412 and content-holding blisters 411 are disposed on opposing sides thereof. It is envisaged that the reinforcing structure 415 shown in the example of FIG. 1-16 may be employed in the foregoing embodiments. The primary package 410 can be employed in combination with the sleeve illustrated in FIGS. 1-3 to 1-7, to form a packaging system.

Turning now to FIG. 1-17, there is illustrated a cross section, taken along line B-B shown in FIG. 1-7, of the rear end portion of the sleeve 700 containing the primary package 410 shown in FIG. 1-16, in which a force is applied, in the direction of arrow F, to the primary package 410, placing the primary package 410 in a state of tension. The region of the primary package 410 between the first series of blisters 416 and the second series of blisters 418 is deformed, such that rather than being folded along the hinged connection 419 the primary package 410 has folded about a first location disposed proximate to the front wall 405 of the first blister 416 and has folded about a second location disposed proximate the rear wall 407 of the second blister 418. This deformation has the effect of moving the retention tab 414 in a generally downward direction. That is, away from the front panel 710 and auxiliary panels 730, 740, thereby reducing the effectiveness of the engagement between the retention tab 414 and the recess R.

Furthermore, the displacement of the retention tab 414 increases the likelihood that retention tab 414 may unfold, as indicated by direction arrow D1 since, as a result of the deformation, the retention tab 414 is now pivotable about a location disposed proximate the back panel 720. The deformation has increased the headroom available to the retention tab 414 for unfolding when compared to headroom available when in a relaxed or untensioned state.

Referring now to FIGS. 1-18 to 1-24, there are shown further alternative embodiments of the present invention. In the fifth, sixth and seventh illustrated embodiments, like numerals have, where possible, been used to denote like parts, albeit with the addition of the prefix “500”, “600” or “800” and so on to indicate that these features belong to the fifth, sixth or seventh embodiment. The further alternative embodiments share many common features with the foregoing embodiments and therefore only the differences from the embodiments illustrated in FIGS. 1-1 to 1-17 will be described in any greater detail.

FIG. 1-18 illustrates a plan view of a primary package 510 according to a fifth embodiment; the primary package 510 can be employed in combination with the sleeve 700 illustrated in FIGS. 1-3 to 1-7.

The primary package 510 in the form of an inner slide card or lockable slide card comprises a main body 512 having a plurality of cavities or blisters 511 for receiving an article such as, but not limited to, a medicament.

A retention tab 514, also known as a tail locking flap, is hinged to the first end of the main body 512. The retention tab 514 is employed to lock the primary package 510 within the sleeve 700 in a first position in which the primary package 510 is fully inserted into the sleeve 700. The retention tab 514 may also be employed to restrict withdrawal of the primary package 510 from the sleeve 700; the retention tab 514 is configured so as to engage with the retention feature 734 provided upon the sleeve 700.

A first series of empty blisters 516 are provided on the main body 512. A second series of blisters 518 are provided on the retention tab 514. The second series of blisters 518 are substantially triangular or wedge-shaped in cross-section as illustrated by FIG. 1-20A. Alternatively, the second series of blisters 518 may be substantially triangular or wedge-shaped in cross-section as illustrated by FIG. 1-20B.

An empty blister 530 is disposed at each end of the second series of blisters 518. Each of the empty blisters 530 is orientated at angle to the adjacent one of the empty blisters 518 of the second series. The angle is optionally between 40 and 50 degrees, for example 45 degrees. The empty blisters 530 are substantially triangular or wedge shaped in cross-section as illustrated by FIG. 1-20B. (Alternatively, the empty blisters 530 may be substantially triangular or wedge shaped in cross-section as illustrated by FIG. 1-20A; all the blisters 518 of the second series as well as the empty blisters 530 may have the same cross section such as shown in either FIG. 1-20A or 1-20B. Otherwise, one or some of the blisters 518 and 530 may be of the cross section of one of FIGS. 1-20A and 1-20B while the other(s) of the blisters 518 and 530 may be of the cross section of the other of FIGS. 1-20A and 1-20B.) Each of the empty blisters 530, when viewed in plan view from above, are substantially stadium shaped, that is to say a rectangle with top and bottom lengths whose ends are capped off with semicircles. A first end of each of the empty blisters 530 is disposed adjacent to a respective one of the first series of empty blisters 516; a second end of each of the empty blisters 530 is disposed adjacent to a free end of the retention tab 514. The first end of each of the empty blisters 530 is disposed in closer proximity to the adjacent one of the empty blisters 518 of the second series than the second end of the empty blister 530. In this way the empty blisters 530 are convergent with respect to each other towards the main body 512.

The first series of empty blisters 516 are disposed in close proximity to the second series of blisters 518. In the illustrated embodiment the blisters 518 of the first series are in contact with, or touching, the adjacent blisters 518 of the second series.

The first and second series of blisters 516, 518 are arranged so as to be proximate a notional line N, shown in FIG. 1-19. In some embodiments the blisters 516, 518 of each of the first and second series of blisters 516, 518 are spaced a distance of 1 mm or less from the notional line N. In another embodiment the blisters 516, 518 of each of the first and second series of blisters 516, 518 are spaced a distance of 0.5 mm or less from the notional line N. In yet another embodiment the blisters of each of the first and second series of blisters 516, 518 are arranged close to each other such that some or all of the empty blisters 518 on the retention tab 514 terminate on the single notional line N on which some or all of the empty blisters 516 on the main body 512 also terminate. Such an arrangement will allow the retention tab 514 to be folded along the notional line N with respect to the main body 512 when a folding force is applied to the retention tab 514. The notional line N defines a region of the primary package 510 along which it is folded, and as such defines an interface between the retention tab 514 and the main body 512. In some embodiments at least a portion of the rear wall of the blister 518 may be substantially in contact with the front wall of the blister 516.

The primary package 510 comprises a pair of hinged connections 517 in the form of formed or moulded score lines 517. The hinged connections 517 extend respectively from the opposed side edges of the retention tab 514 (or those of the main body 512) and stop short of each other to leave a section between the hinged connections 517 where there is no hinged connection. Both the hinged connections 517 are co-formed with the blisters 511, 516, 518 and 530. The hinged connections 517 are integrally formed within the sheet of material forming the main body 512 and retention tab 514, as best illustrated in FIGS. 1-21 and 1-22. The hinged connections 517 are each a formed score line and are each an integral formation within the primary package 510. The sheet of material, from which the retention tab 514 and main body 512 are both formed, is deformed during the moulding process such that a formed score line having a substantially U-shaped cross section is created. In other embodiments the score line may take alternative shapes, for example, but not limited to, a V-shaped notch; a V-shaped notch which may have a flat base portion between the side walls; or a square notch having a flat base portion and upright side walls. A first of the hinged connections 517 extends from a first free side edge of the primary package 510 partially across the primary package 510. The first of the hinged connections 517 is arranged to be substantially perpendicular to the first free side edge of the primary package 510. A second of the hinged connections 517 extends from a second free side edge of the primary package 510; the second free edge opposes the first free edge partially across the primary package 510. The second of the hinged connections 517 is arranged to be substantially perpendicular to the second free side edge of the primary package 510. The first and second hinged connections 517 are arranged to be collinear with each other.

The notional line N extends between the pair of hinged connections 517 so as to form a continuous fold line when the retention tab 514 is folded about the hinged connections 517 with respect to the main body 512. The fold line, when fully formed, is linear and extends transversely across the primary package 510. The notional line N is collinear with the first and second hinged connections 517. The notional line N interrupts the first and second hinged connections 517.

Referring to FIG. 1-22 it can be seen that the empty blisters 530 are disposed at a distance “y” from the centre of the hinged connection 517. The empty blisters 516 are disposed at a distance “z” from the centre of the hinged connection 517. The empty blisters 516 are disposed at a distance equal to the sum of the distance “y” and the distance “z” from the empty blisters 530.

Optionally, the distance “y+z” is less than or equal to about 5 mm, and more optionally equal to or less than 2 mm. Each false blister 516, 518 is spaced a distance of about 2.5 mm or less, and optionally about 1 mm or less, from the hinged connection 517.

FIG. 1-23 illustrates a plan view of a primary package 610 according to a sixth embodiment; the primary package 610 can be employed in combination with the sleeve 700 illustrated in FIGS. 1-3 to 1-7.

The primary package 610 in the form of an inner slide card or lockable slide card comprises a main body 612 having a plurality of cavities or blisters 611 for receiving an article such as, but not limited to, a medicament.

A retention tab 614, also known as a tail locking flap, is hinged to the first end of the main body 612. The retention tab 614 is employed to lock the primary package 610 within the sleeve 700 in a first position in which the primary package 610 is fully inserted into the sleeve 700. The retention tab 614 may also be employed to restrict withdrawal of the primary package 610 from the sleeve 700; the retention tab 614 is configured so as to engage with the retention feature 734 provided upon the sleeve 700.

A first series of empty blisters 616 are provided on the main body 612. A second series of blisters 618 are provided on the retention tab 614. The second series of blisters 618 are substantially triangular or wedge-shaped when viewed from the side.

An empty blister 630 is disposed at each end of the second series of blisters 618. Each of the empty blisters 630 is orientated at angle to the adjacent one of the empty blisters 618 of the second series of blisters 618. The angle is optionally between 40 and 50 degrees, for example 45 degrees. The empty blisters 630 are substantially triangular or wedge-shaped when viewed from the side. Each of the empty blisters 630, when viewed in plan view from above, are substantially stadium shaped, that is to say a rectangle with top and bottom lengths whose ends are capped off with semicircles. A first end of each of the empty blisters 630 is disposed adjacent to a respective one of the first series of empty blisters 616; a second end of each of the empty blisters 630 is disposed adjacent to a free end of the retention tab 614. The first end of each of the empty blisters 630 is disposed in closer proximity to the adjacent one of the empty blisters 618 of the second series of blisters 618 than the second end of the empty blister 630. In this way the empty blisters 630 are convergent with respect to each other towards the main body 612.

A pair of recesses or cutaways C is struck from the retention tab 614. Each of the recesses or cutaways C is disposed between an empty blister 630 and the adjacent endmost blister 618 of the second series of blisters 618.

The first series of empty blisters 616 are disposed in close proximity to the second series of blisters 618.

The retention tab 614 is hinged to the main body by a hinged connection 617. The hinged connection 617 extends transversely across the width of the retention tab 614 (or that of the main body 612). The hinged connection 617 is co-formed with the blisters 611, 616, 618 and 630. The hinged connection 617 is integrally formed within the sheet of material forming the main body 612 and retention tab 614. The hinged connection 617 is an interrupted formed score line and is an integral formation within the primary package 610. The sheet of material, from which the retention tab 614 and main body 612 are both formed, is deformed during the moulding process such that a formed score line having substantially U-shaped cross section is created.

In the illustrated embodiment the hinged connection 617 is interrupted in three locations such that the hinged connection 617 forms a plurality of (four) spaced apart integrally formed score lines 617.

The location of each of the interruptions corresponds with a gap or void between two adjacent rows of blisters 611. The interruptions each define a notional line N which is collinear with the plurality of spaced apart integrally formed score lines. Each notional line N extends between a pair of adjacent ones of the plurality of spaced apart integrally formed score lines. The blisters 611 are arranged in a matrix or array, so as to form rows and columns. The blisters 611 in one row or column are spaced apart from those in an adjacent row or column. This forms a plurality of (three) longitudinally extending voids on the main body 612. Optionally, a plurality of transversely extending voids is formed on the main body 612. Each of the interruptions in the hinged connection 617 is collinear with one of the plurality of longitudinally extending voids defined upon the main body 612 by the blisters 611.

FIG. 1-24 illustrates a plan view of a primary package 810 according to a seventh embodiment; the primary package 810 can be employed in combination with the sleeve 700 illustrated in FIGS. 1-3 to 1-7.

The primary package 810 in the form of an inner slide card or lockable slide card comprises a main body 812 having a plurality of cavities or blisters 811 for receiving an article such as, but not limited to, a medicament.

A retention tab 814, also known as a tail locking flap, is hinged to the first end of the main body 812. The retention tab 814 is employed to lock the primary package 810 within the sleeve 700 in a first position in which the primary package 810 is fully inserted into the sleeve 700. The retention tab 814 may also be employed to restrict withdrawal of the primary package 810 from the sleeve 700; the retention tab 814 is configured so as to engage with the retention feature 734 provided upon the sleeve 700.

A first series of empty blisters 816 are provided on the main body 812. A second series of blisters 818 are provided on the retention tab 814. The second series of blisters 818 are substantially triangular or wedge shaped when viewed from the side.

The first series of empty blisters 816 are disposed in close proximity to the second series of blisters 818.

The retention tab 814 is hinged to the main body by a hinged connection 817. The hinged connection 817 extends transversely across the width of the retention tab 814 (or that of the main body 812). The hinged connection 817 is co-formed with the blisters 811, 816 and 618. The hinged connection 817 is integrally formed within the sheet of material forming the main body 812 and retention tab 814. The hinged connection 817 is an interrupted formed score line and is an integral formation within the primary package 810. The sheet of material from which the retention tab 814 and main body 812 are both formed, is deformed during the moulding process such that a formed score line having substantially U-shaped cross section is created.

In the illustrated embodiment the hinged connection 817 is interrupted in eight locations such that the hinged connection 817 forms a plurality of (nine) spaced apart integrally formed score lines.

The blisters 811 are arranged in a matrix or array, so as to form rows and columns. The blisters 811 in one row or column are spaced apart, by gaps, from the blisters 811 in an adjacent row or column. This forms a plurality of longitudinally extending valleys or voids V on the main body 812. Optionally, a plurality of transversely extending voids is formed on the main body 812. It will be appreciated that the longitudinally extending voids V are elongate regions of the primary package 810 which are free from blisters 811.

Each of the empty blisters 816 of the first series of empty blisters 816 is configured so that it is in longitudinal alignment with one of the rows of blisters 811 provided on the main body 812.

Each of the empty blisters 818 of the second series of empty blisters 818 is configured so that it is in longitudinal alignment with one of the rows of blisters 811 provided on the main body 812.

In this way the longitudinally extending voids V on the main body 812 between the blisters 811 extend across the main body 812 and across the retention tab 814. The longitudinally extending voids V are indicated in FIG. 1-24 by notional lines N1 to N8 shown as phantom (dashed) lines

The location of each the interruptions of the hinged connection 817 corresponds with one of the longitudinally extending voids V. Each of the interruptions in the hinged connection 817 is collinear with one of the plurality of longitudinally extending voids V defined upon the main body 812 by the blisters 811.

Providing interruptions in an integrally moulded hinged connection 517; 617; 817 is advantageous when handling the primary packages 510; 610; 810. In some embodiments a plurality of primary packages 510; 610; 810 are formed from a sheet of material and then subsequently separated from each other by a cutting or separation process. FIG. 1-25 illustrates an example in which a plurality of primary packages 810 is formed from a sheet 1000. In the illustrated example six primary packages 810 are formed from the sheet 1000; however, in other embodiments other integer numbers of primary packages 810 may be provided. FIGS. 1-26A and 1-26B illustrate the sheet 1000 being conveyed to a roller device D of a processing machine. At the roller device D the primary packages 810 are cut from the sheet of material 1000, or in alternative embodiments the primary packages 810 are separated from each other, by a cutting or separating device (not shown) whilst being bent or deformed about the roller device D. The sheet of material 1000 which has been moulded with the blisters 811 and empty blisters 816, 818 and the hinged connections 817 is conveyed, as indicated by direction arrow A1, to the roller device D such that that the hinged connections 817 are orientated perpendicularly with respect to a tubular axis L of the roller device D. The interruptions in the hinged connections 817 facilitate bending of the sheet of material S about the roller device D. It will be appreciated that when the hinged connections 817 are solid, that is to say uninterrupted, the hinged connections 817 encumber or resist bending or deformation of the sheet of material 1000 about the roller device D.

It is further advantageous for the empty or false blisters 816, 818 and the product carrying blisters 811 to be configured so as to provide flat or unformed regions which extend across the sheet of material 1000. These longitudinally extending voids V are arranged to be parallel with the tubular axis L of the roller device D and are arranged transversely with respect to the direction of travel A1.

Yet a further advantage of aligning the interruptions in the integrally moulded hinged connection 517; 617; 817 with the voids between rows (or columns) of blisters 811, 816, 818 is that a predefined bend region is provided such that the sheet of material 1000 is encouraged to bend in the predefined bend region and discouraged from bending in the region where blisters 811, 816, 818 are provided. This is especially advantageous in embodiments in which products are loaded into the product carrying blisters 811 and sealed therein with a cover sheet before being conveyed to a roller device D, thereby preserving the integrity of the product carrying blisters 811.

It will be appreciated that by providing an integrally moulded hinged connection 17; 117; 217; 317; 517; 617; 817 that a processing step is removed from the manufacturing process of the primary package 10; 110; 210; 310; 510; 610; 810.

Additionally, the child resistant features of the primary package 10; 110; 210; 310; 510; 610; 810 is enhanced since the empty blisters 16, 18; 116, 118; 218; 316, 318; 516, 518, 530; 616, 618, 630; 816, 818 are disposed in close proximity to the hinged connection 17; 117; 217; 317; 517; 617; 817 thereby reducing the likelihood of deformation of the primary package 10; 110; 210; 310; 510; 610; 810 in the region of the hinged connection 17; 117; 217; 317; 517; 617; 817 or at least increasing the magnitude of the force which must be applied to forcibly remove the primary package 10; 110; 210; 310; 510; 610; 810 from the sleeve 700 when in a locked configuration, in other words without disengaging the locking mechanism formed by the retention tab 14; 114; 214; 314; 514; 214; 814 and the recess R.

Referring now to FIGS. 2-1 through 2-13, the second invention is described referring to multiple embodiments illustrated in those figures.

The present invention provides a restricted access package ‘P’ comprising a lockable receptacle (e.g., a blister strip, an inner slide card, a slidable tray or box, etc.) 10 and an outer shell 700. The lockable receptacle 10 and outer shell 700 have co-operative features which can lock the receptacle 10 within the outer shell 700 to thereby allow only restricted access to the receptacle 700. Additionally, the receptacle 10 and outer shell 700 of the present invention have co-operative features to enable the receptacle 10 to be unlocked and at least partially withdrawn or slid out from the outer shell 700 so that a user may access the blisters ‘B’ and articles held therein. In a locked configuration of the package ‘P’, the receptacle 10 is stowed within the respective outer shell 700 and locked in place by a mechanical complementary locking mechanism such that the articles held in the cavity or cavities ‘B’ cannot be accessed. Operation of a release mechanism is required in order to unlock the receptacle 10 from the outer shell 700 and to allow its withdrawal from the outer shell 700.

Operation of the release mechanism requires knowledge of the operation of the locking mechanism and some dexterity to operate the unlocking features and, at the same time, withdraw the lockable receptacle. In this way, access to the lockable receptacle may be restricted to only those users of sufficient knowledge and dexterity.

As a further optional aspect of the invention, it is envisaged that in certain embodiments, the lockable receptacle 10 and outer shell 700 may have co-operative features to prevent, restrict or otherwise mitigate against the receptacle 10 from being completely removed from the outer shell 700. An unlocked configuration is illustrated in FIG. 2-1, wherein the blister strip 10 is disengaged and withdrawn, albeit only to a permitted and limited extent, from the outer shell 700.

It will be understood upon reading the foregoing that the present invention provides an outer shell 700 with beneficial features, and a lockable receptacle 10, 110 with beneficial features. The outer shell 700 and lockable inner receptacle 10, 110 are usable with one another and optionally, benefit may be found by utilising the outer shell with its beneficial features with other lockable receptacles, and/or by utilising the lockable receptacle with its beneficial features with other outer shells or outer sleeves.

Referring now to FIG. 2-1, there is shown a perspective view of a lockable receptacle in the form of a blister strip 10 or inner slide card 10 that comprises a main portion 12. The blister strip 10 of the illustrated embodiment is a thermoformed plastic sheet (for example PVC). A main portion 12 of the blister strip 10 has at least one receiving cavity ‘B’ for holding an article. The at least one receiving cavity ‘B’ is formed as a protrusion of a first (upper) surface 15 and as an indentation of a second (lower) surface 27. In the illustrated arrangement of FIGS. 2-1 to 2-5, the blister strip 10 has twenty-eight blisters or cavities ‘B’, each for receiving an article (not shown). Optionally, the inner slide card 10 or blister strip 10 may be lidded or sealed with a backing sheet ‘S’, such as an aluminium foil sheet, paperboard layer, polymeric film and/or other perforable or peelable material (see FIG. 2-9). Whereas perforable films are often used in pharmaceutical push-through packages, where a tablet is pushed out of the blister ‘B’ and this action breaks the backing film to allow that tablet to exit the blister ‘B’, in other embodiments the backing film may, for example, be peelable and therefore not necessarily of the push-through type. The embodiments described having punch-through backing sheets are for illustrative purposes only and are not limiting.

In other envisaged embodiments, the inner slide card 10 or blister strip 10 may be formed of other sheet material, for example other plastics or paperboard. In other arrangements, the blister strip 10 may have one or more blisters ‘B’ integrally formed therein, and may only optionally be formed by thermoforming. Alternatively or additionally, the inner slide card 10 may comprise two parts, a card type element (not shown) and a blister strip 10, the blister strip 10 being attached to the card-type element such that the two parts together form a unitary element that is capable of accommodating one or more articles in individual cavities, and that is capable of being withdrawn from and pushed by relative sliding movement into an outer shell 700. The articles to be accommodated by the blisters ‘B’ of the inner slide card 10 may, for example, be tablets, pills capsules or, for example, any other form of medicament, healthcare item, personal item, drug, vitamin, electrical component or other article. The inner slide card 10 or blister strip 10 may be capable of holding one or more items or articles. The terms ‘inner slide card 10’ and ‘blister strip 10’ are used to refer to components that are placed inside the outer shell 700 and to which the blisters or cavities ‘B’ are attached, or within which the blisters or cavities ‘B’ are integrally formed. The terms inner slide card 10′ and ‘blister strip 10’ may be used to refer to components formed of paperboard, plastics material, or combinations of material, and such components may be formed from a single piece of material or a composition of different materials.

In the illustrations accompanying the description, the blister strip 10 is shown with a series of empty blisters ‘B’. It will be understood that when reference to a package ‘P’ is made herein, it may mean a package ‘P’ containing an inner slide card 10 having, or not having, articles disposed and sealed within the blister cavities ‘B’.

Turning now in more detail to the structure of the blister strip 10 or inner slide card 10 shown in FIGS. 2-1 to 2-5, the inner slide card 10 comprises a main portion 12, in which article holding cavities ‘B’ are formed. In the illustrated inner slide card 10, twenty-four cavities ‘B’ are formed. The cavities ‘B’ project from an upper surface 15 (also referred to as ‘first surface’) of the main portion 12. The underside 27 (also referred to as ‘second surface’) of the main portion 12 can have a backing sheet attached thereto to retain and seal an article within each cavity ‘B’ once the blister strip 10 has been loaded with articles.

The leading edge 21 of the slide card 10 is the edge that first exits the outer shell 700 when the slide card 10 is withdrawn from the outer shell 700 (see FIG. 2-1). A locking tail flap 14 is formed at the opposite end of the blister strip 10 and is connected by a hinge 17 (optionally formed as a creased or demarcated or perforated or otherwise weakened fold line 17) to a trailing end of the main portion 12 of the blister strip 10 or slide card 10 (see FIGS. 2-2 through 2-5). Opposite to the hinge 17 is a free edge of the locking tail flap 14. The free edge comprises a medial engaging portion 22. Disposed on either side of the medial engaging portion 22 are wing portions 20a, 20b. The maximum width W14 of the locking tail flap 14 proximate the medial engaging portion 22 is approximately the same width as the maximum width W12 of the main portion 12 of the blister strip 10 (see dimension lines W14 and W12 in FIG. 2-2). Preferably, but nevertheless optionally, the maximum width W14 of the locking tail flap 14 proximate the medial engaging portion 22 is substantially equal to or slightly less than the internal width W700 of an outer shell 700 (see FIG. 2-12A). When less than the internal width W700, the maximum width W14 is no more than 2 mm (and optionally no more than 1 mm) less than the internal width W700. This arrangement may be represented by the following formula F:W14+d=W700

In the above formula, “W14” is the maximum width of the locking tail 14, “W700” is the internal width of the outer shell 700, and “d” is the difference in dimension between the maximum width W14 and the internal width W700 where “d” may be represented by the following formula: 0≤d≤2 mm.

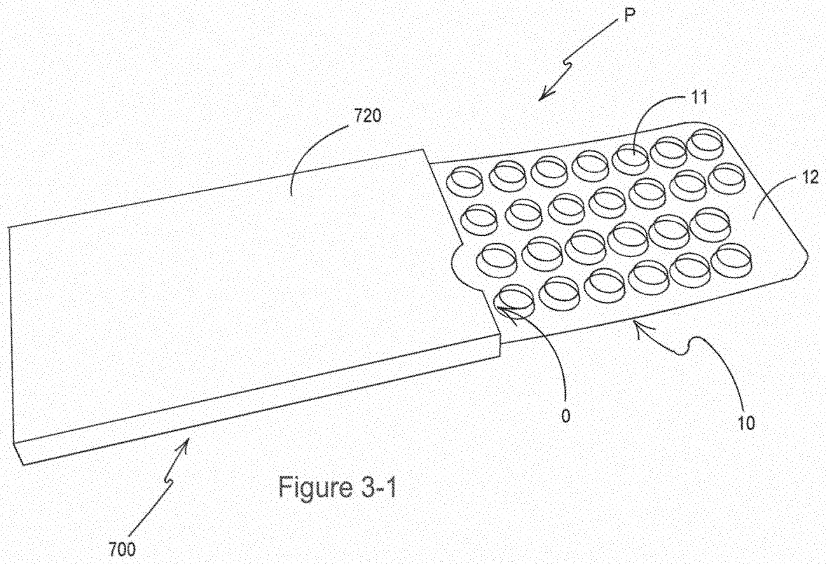

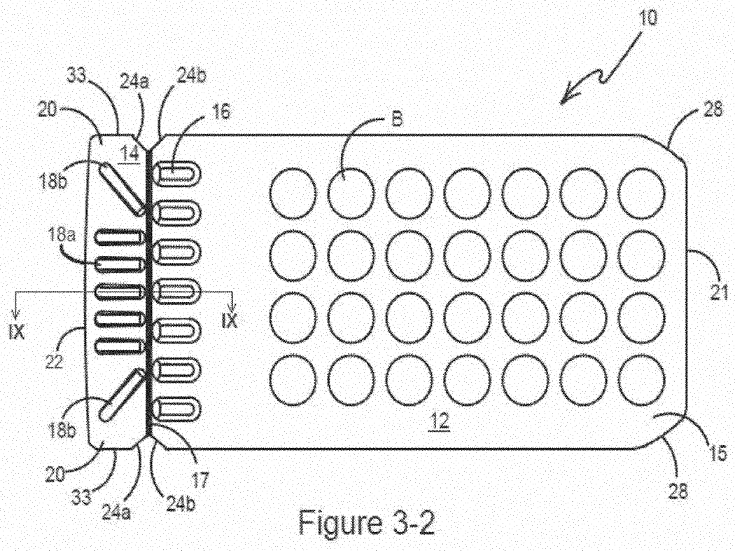

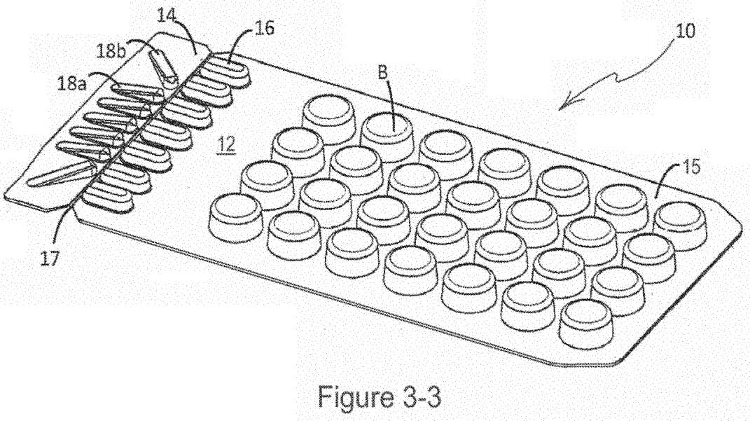

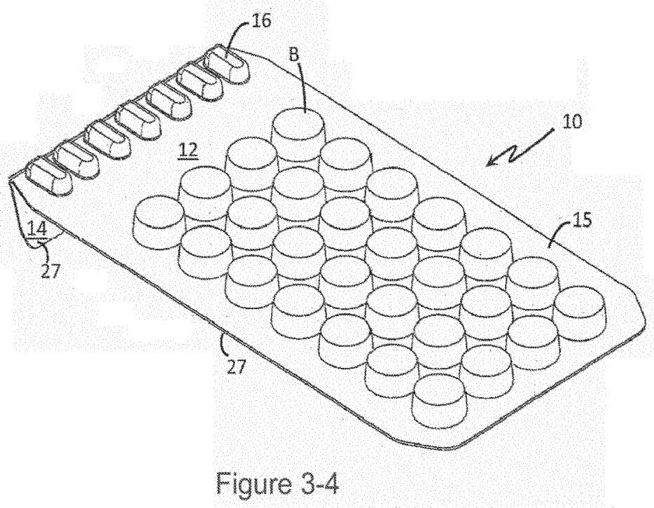

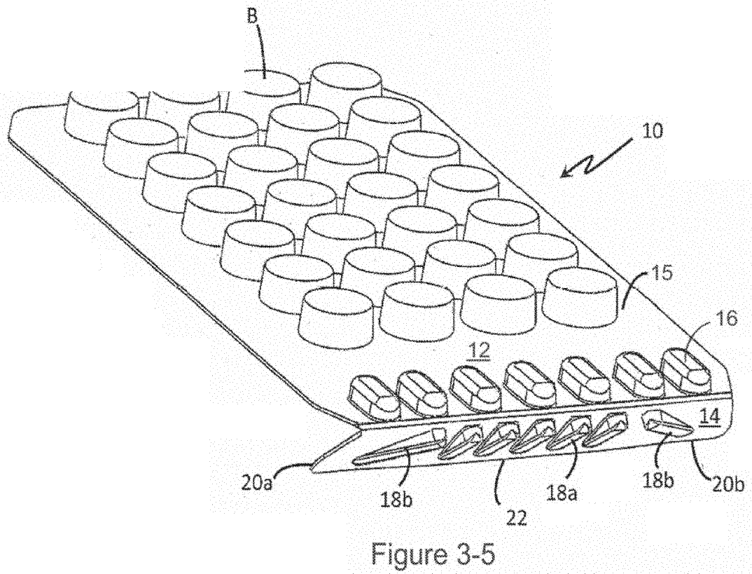

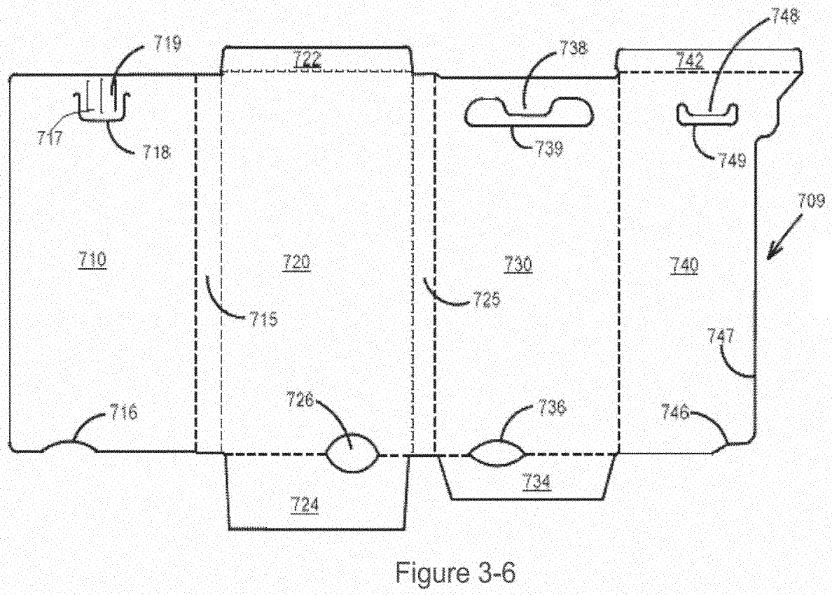

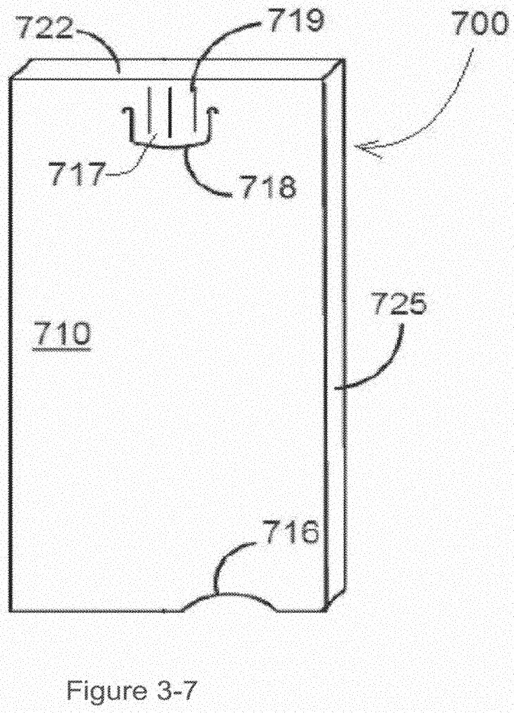

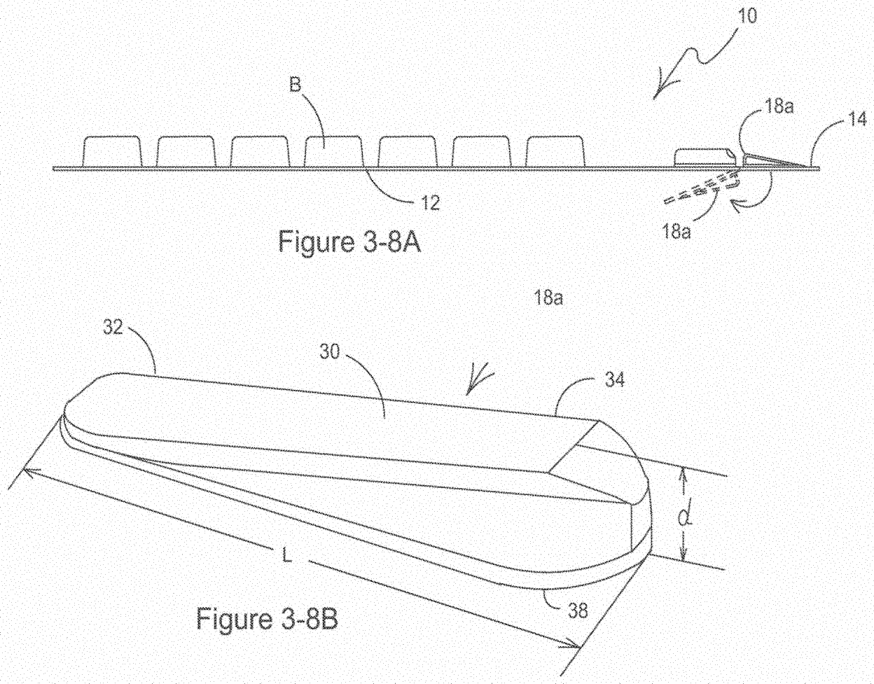

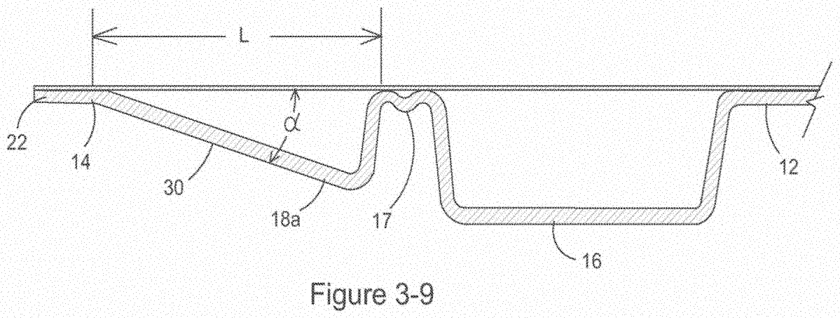

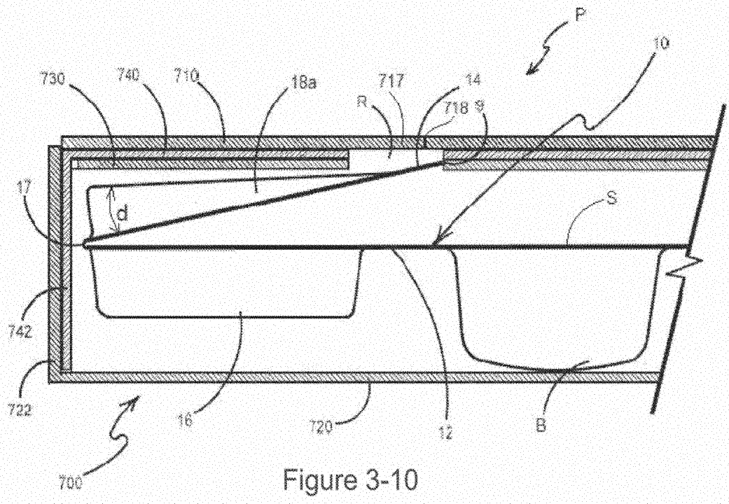

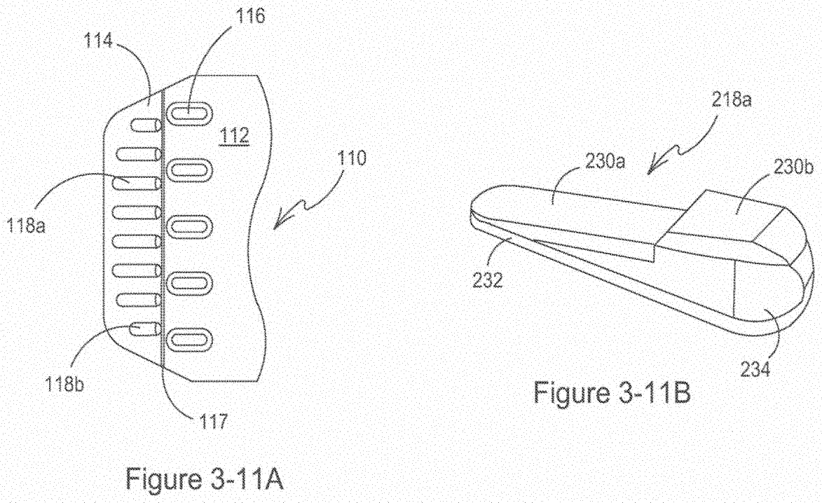

Optionally, the blister strip 10 and locking tail flap 14 may comprise complementarily shaped tapered edge portions 24a, 24b proximate to and terminating on the hinge connection 17. When the locking tail flap 14 is folded relative to the main portion 12, the tapered portions 24a of the locking tail flap 14 are moved closer to the tapered portions 24b of the blister strip 10. As a result of the tapered portions 24a, 24b, the folded blister strip 10 has a narrower width edge defined by hinge connection 17 that becomes the leading edge when the blister strip 10 is being loaded into an outer shell 700. The co-operatively tapered shaped portions 24a, 24b thereby assist with the easy installation of the folded blister strip 10 into an outer shell 700. As such, the locking tail flap 14 has a region (along hinge connection 17) where the width of the locking tail flap 14 may be less than the maximum end-to-end width W14 between the side edges 33 (see FIGS. 2-2 and 2-3) of the locking tail flap 14. Optionally, the side edges 33 each includes at least a straight portion. Alternatively or more optionally, the maximum end-to-end width of the locking tail flap 14 is equal to, or greater than, the maximum end-to-end width W12 of the main portion 12 of the blister strip 10. This preferred arrangement may be represented by the following formula G: W14≥W12.

In the above formula, “W14” is the maximum width of the locking tail flap 14 and “W12” is the maximum width of the main portion 12 of the blister strip 10. The arrangement represented by the above formula F and/or formula G effectively contributes to providing a good bracing effect between side walls 715, 725 of an outer shell 700 (which will be described below in reference to FIGS. 2-12A and 2-12B), which beneficially may limit the risk of, or prevent, the locking tail flap 14 from being unfolded relative to the main portion 12. Prior art outer sleeves can suffer from a bowing effect, wherein the front wall 740/730/710 and bottom wall 720 can bow outwardly (as viewed from the exterior of the outer shell 700). To achieve this, the side walls 725 and 715 must be able to move towards one another. If the outer shell 700 can be distorted in this manner, and to a sufficient degree, the internal height of the outer shell 700 can be increased to provide sufficient headroom such that the locking tail flap 14 can be unfolded. Once the locking tail flap 14 is unfolded, the blister strip 10 can be withdrawn from the outer shell 700. Squeezing the side wall 725, 715 and forcing the blister strip 10 out of the sleeve 700 in such a manner avoids the use of the release mechanism, and effectively overcomes the child-resistant features. This is disadvantageous. Beneficially, however, in the blister strips of the present invention, the locking tail flap 14 is shaped such that its maximum width W14 and optional straight side edges 33 provide a brace or strut between the side walls 725, 715 of the outer shell 700 and prevent the outer shell 700 from being distorted as described. A package of the present invention may therefore retain its child-resistant features and provide an important improvement that could safeguard against a child gaining unauthorized access to medication.

Optionally, the free-edge 20a/22/20b of the locking tail flap 14 may be shaped to enhance the locking engagement of the locking tail flap 14 with the outer shell 700.

Optionally, one or more integral formations 18a, 18b, each formed as a protrusion of the first surface 15 and as an indentation of the second surface 27 are provided on the locking tail flap 14. The one or more integral formations each have a non-uniform height. The one or more integral formations, which may also be referred to as false blisters 18a, 18b herein, are provided on or integrally formed within the locking tail flap 14. The one or more false blisters 18a, 18b are configured such that they can each provide a degree of reinforcement or rigidity to the locking tail flap 14 to help prevent bowing of the tail flap and at the same time fit within the outer shell 700 when the locking tail flap 14 is disposed in its locking position.

In use, the locking tail flap 14 is folded about hinge connection 17 toward the underside (backed) surface of the main portion 12 of the blister strip 10 and away from the false blisters 16. This folded configuration results in the false blisters 18a, 18b projecting above the locking tail flap 14 and between the upper composite wall 730/740/710 of the outer shell 700 and the locking tail flap 14. This is best illustrated in FIGS. 2-9 and 2-10, which shows the locked configuration of the package ‘P’. In alternative embodiment, however, the locking tail flap 14 may be folded about hinge connection 17 toward the false blisters 16 and toward the non-backing side of the main portion 12 opposite to the backing side thereof where the backing sheet or foil is placed. This folded configuration would result in the false blisters 18a, 18b projecting from the locking tail flap 14 toward the false blisters 16 and located between the locking tail flap 14 and the false blisters 16. In such an embodiment, the false blisters 18a, 18b tend to be brought into direct contact with the false blisters 16 as the locking tail flap 14 is folded, and thereby function as a spacer or even added spring between the locking tail flap 14 and the main portion 12. As a result, the blisters 18a, 18b, 16 prevent the locking tail flap 14 from being folded 180 degrees or all the way to the non-backing side of the main portion 12. Such an arrangement would be useful to reduce the chance of unintentional disengagement of the locking tail flap 14 from a recess ‘R’ of the outer shell 700—the recess ‘R’ will be discussed in more details later.

In the illustrated embodiment, a series of further optional false blisters, ribs, or other formations 16 are provided on the main portion 12 of the blister strip 10.

The false blisters 18a, 18b, 16 are optionally press-formed or moulded out of the locking tail flap 14 and main portion 12. Optionally, the false blisters 18a, 18b, 16 may be integrally formed with the locking tail flap 14 or affixed thereto. Where the false blisters 18a, 18b are integrally moulded out of the locking tail flap 14 the underside 27 of the locking tail flap 14 may have indentations corresponding to the impression of the false blisters 18a, 18b.

The false blisters 18a may be disposed in series of one or more, five for example, substantially parallel false blisters 18a. These false blisters 18a may provide a degree of rigidity to the locking tail flap 14, and may assist in the appropriate or desired bending or flexing of the locking tail flap 14 when the locking tail flap 14 is engaged with the outer shell 700, and/or deflected to cause unlocking of the locking tail flap 14 from the outer shell 700. Optionally, one or more obliquely angled false blisters 18b may be provided on the wing portions 20a, 20b of the locking tail flap 14 and beneficially provide rigidity to the corner wing portions 20a, 20b which may improve the strength of the brace provided by the “full-width” locking tail flap 14. Optionally, the obliquely angled false blisters 18b may be directed towards the corners of the locking tail flap and may reinforce, strengthen or otherwise enhance the rigidity of the corners of the locking tail flap 14. In the illustrated configuration, two obliquely angled false blisters 18b are provided on the locking tail flap 14, each directed from proximate the hinge connection 17 and towards each corner of the locking tail flap 14. At least one false blister is optionally pressed or moulded out of the locking tail flap 14. The number, size, and configuration of the false blisters 18a, 18b provided on the locking tail flap 14 may be varied from that illustrated. It should be readily understood that the closer the false blisters 18a, 18b on the locking tail flap 14 are to the false blisters 16, the greater the structural strength of the locking tail flap 14. The greater the structural strength of the locking tail flap 14, the more reliable the engagement of the locking tail flap 14 with the outer shell 700. The false blisters 18a, 18b may be extended all the way to the free/engaging edge of the locking tail flap; however, the arrangement wherein the false blisters 18a, 18b stop in short of the engaging edge of the locking tail flap and thereby a flat, no blister area is left between the engaging edge and the false blisters may interact better with the outer shell for the purpose of providing reliable engagement of the locking tail flap and the outer shell.

In the present arrangement, the blister strip 10 is arranged such that the locking tail flap 14 folds about hinge 17 and towards the underside 27 of the main portion 12 of the blister strip 10. This folded configuration is shown in FIGS. 2-4 and 2-5. As a result of the locking tail flap 14 being folded relative to the main portion 12 of the blister strip 10 in this way (rather than the upper-side 15 of the locking tail flap 14 being folded towards the upper side 15 of the main portion 12 of the blister strip 10), the surface of the locking tail flap 14 that is closest to the internal locking aperture 739/749 (described below) of the outer shell or sleeve 700, is the upper-side surface 15, from which the false blisters or reinforcing ribs 18a, 18b project upwardly. The locked position of the blister strip 10 within the outer shell 700 is shown in FIG. 2-10, wherein the location of the false blisters or reinforcing ribs 18a, 18b is shown.

In FIG. 2-7, there is shown a perspective view of an optional and exemplary outer shell 700 capable of receiving the blister strip 10 for forming a package ‘P’ (see FIG. 2-1). The outer shell 700 may be formed from a variety of materials, for example, plastics material, paperboard material and/or combinations of these and other materials.

Optionally, and as illustrated, the outer shell 700 may be formed from foldable sheet material, for example paperboard. In FIG. 2-6, an exemplary embodiment of a blank 709 is illustrated. The blank 709 is for forming an exemplary outer shell 700 for use with an exemplary blister strip 10.

As illustrated, the outer shell (also referred to as a ‘sleeve’) 700 forms a generally tubular structure (see FIGS. 2-1 and 2-7) with a generally rectangular cross section. Blank 709 has a series of foldably attached panels including: a front panel 710, first side panel 715, back panel 720, second side panel 725, first auxiliary panel 730, and second auxiliary panel 740.

Front panel 710 may include a release button in the form of an area denoted by a cut line 718 which may be generally U-shaped. The release button may have score lines, ribs, crease lines or other formations 719 to provide stiffness to the release button. A cut-away portion 716 may be provided which may coincide with other cut-away portions 726, 736 in the finished sleeve 700.

Back panel 720 at a “closed” end may be hingedly attached to a first or outer end closure flap 722. Back panel 720 at its opposite “open” end may be provided with an inward facing flap 724 that may be useful for retaining contents within the sleeve (for example, by its natural resilience causing the folded inward facing flap 724 to be urged towards its unfolded position, in which it releasably closes the “open” end of the outer shell 700). A cutaway 726 may be provided, which may coincide with other cutaways 716, 736 in the finished sleeve 700.

The first auxiliary panel 730, which becomes an innermost ply of a composite front wall 710/740/730, comprises an aperture 739 shaped to engage at least part of the locking tail flap 14 of the blister strip 10. Release tongue 738 may extend into the aperture 739 to act along with release button 718 and a release tongue 748 in releasing the engaged part of the locking tail flap 14. At the other end of the first auxiliary panel 730 an inward facing flap 734 may be provided. The inward facing flap 734 may be useful for retaining contents within the sleeve 700, optionally by engagement of the locking tail flap 14 against an edge of that inward facing flap 734. A cutaway 736 may be provided, which may coincide with other cutaways 716, 726 in the finished sleeve 700.

The second auxiliary panel 740, which becomes an intermediate-ply of the composite front wall 710/740/730, comprises an aperture 749 shaped in correspondence with, and positioned in alignment with, aperture 739. The aperture 749 is also arranged to engage at least part of the locking tail flap 14 of the blister strip 10. Release tongue 748 may extend into the aperture 749 to act along with release button 718 and release tongue 738 in releasing the engaged part of the locking tail flap 14. For example the release button 718, release tongue 738, and release tongue 748 may all deflect inward when a user applies inward pressure to the release button 718. Second auxiliary panel 740 at the “closed” end may be hingedly attached to a second or inner end closure flap 742. At the opposite “open” end, cutaway 746 may be provided which may coincide with other cutaways in the finished sleeve 700. The free side edge 747 of the second auxiliary panel 740 may be shaped such that the second auxiliary panel 740 is not of a uniform width and is partially cut away.

The blank shown in FIG. 2-6 may be folded with the second auxiliary panel 740 folded backwards and behind the first auxiliary panel 730. The auxiliary panels 730, 740 may be attached together, for example by glue or hot melt glue. The release tongues 738, 748 generally overlap in this configuration.

The inward facing flaps 724, 734 may now be folded inwardly upon back panel 720 and first auxiliary panel 730, respectively. These flaps 724, 734 may be held in place by the creased fold, and/or may be glued against their respective panels, or heat sealed thereto. Optionally inward facing flap 734 is adhered to the first auxiliary panel 730 and inward facing flap 724 is not affixed to the back panel 720.

The part-formed structure may then be further folded, with the auxiliary panels 730, 740 folded forward and over back panel 720. This results in a configuration where the back panel 720, second side panel 725, and auxiliary panels 730, 740 make up three walls of a tubular structure. (It should be noted that the use of tear resistant materials, and/or more than one layer, helps to improve the tamper- and theft-resistance of the package.) To finish assembling the sleeve 700, the inner closure flap 742 is first folded downward. The outer closure flap 722 may then be folded upward into facing contact with the inner closure flap 742. The facing surfaces of the outer closure flap 722 and inner closure flap 742 are Optionally both heat seal coated, so that a very strong seal may be created and a composite end closure wall formed at the “closed” end of the outer shell 700.

After the front panel 710 has been folded up and over secondary auxiliary panel 740, these two panels 710, 740 may be affixed together, for example by heat sealing, to form the finished sleeve 700 as shown in FIG. 2-7.

Cutaway 747 in second auxiliary panel 740 allows a portion of the inner surface of front panel 710 (a surface optionally having a heat seal coating) to seal to a portion of the surface of the first auxiliary panel 730 (a surface that may not have the heat seal coating).

As the front panel 710 is secured to both auxiliary panels 730, 740, a composite front wall is formed which has, at least in parts, three plies of material. This creates a stiff composite front wall which may help prevent bowing and enables a recess ‘R’ to be formed (see FIG. 2-10).

The outer shell 700 is configured to receive the blister strip 10 or another suitable inner slide card 10 or blister card 10. As such the composite top wall 710/740/730 and bottom wall 720 of the outer shell 700 are spaced apart and are shaped and dimensioned to create a cavity or inner housing, into which the blister strip 10 can be placed. The blister strip 10 is optionally slidably and reasonably tightly placed into the housing provided by the outer shell 700 and in such a manner that the co-operative mechanical lock between the locking tail flap 14 and engaging apertures 739/749 is able to operate.

In FIG. 2-10, an illustration is provided of a side-view of a cut-away portion of the outer shell 700. This shows how the locking tail flap 14 of the folded blister strip 10 fits securely within the housing provided by the outer shell 700 and how at least part of an engaging portion (also referred to as ‘engaging edge’) 22 of the locking tail flap 14 is disposed within a recess ‘R’ formed within the three-plies of material of the composite front wall 710/740/730 by the apertures 749 and 739 respectively. The locking tail flap 14 has a degree of natural resilience and after being folded about hinge 17, is biased to return to its unfolded state. This degree of resilience causes at least part of the engaging portion (leading edge) 22 of the locking tail flap 14 to position itself within the recess ‘R’ and optionally abut edges of the apertures 739 and/or 749 respectively.

The internal height of the outer shell 700 between the bottom wall and the composite front wall 710/740/730 is variable across the outer shell 700 in the region of the locking apertures 749, 739. To illustrate this, FIG. 2-8 shows an illustration of the outer shell 700 with a ghost outline of the general location of the locking tail flap 14 in its locked state. Two longitudinal reference lines A-A and B-B are also depicted. Along the line A-A, the wing portion 20a of the locking tail flap 14 is disposed beneath the lowermost panel—the first auxiliary panel 730 of the composite front wall 710/740/730. This is depicted in FIG. 2-9, which shows a partial cut-away side view of the outer shell 700 and folded blister strip 10 taken generally along the line A-A. The internal height between the bottom wall 720 and first auxiliary panel 730 is indicated as dimension ‘X’ in FIG. 2-9. However, along the line B-B, the engaging portion 22 of the locking tail flap 14 is disposed within the recess ‘R’ and is disposed immediately beneath the front panel 710 of the composite front wall 710/740/730. This is depicted in FIG. 2-10, which shows a partial cut-away side view of the outer shell 700 and folded blister strip 10 taken general along the line B-B. The internal height between the bottom wall 720 and front panel 710 is indicated as dimension ‘Y’ in FIG. 2-10.

It will be understood, therefore, that the locking tail flap 14 is not flat or planar in its locked state. The addition of the wing portions 20a, 20b and larger structured locking tail flap 14 give rise to a stronger locking mechanism that may provide a greater degree of child resistance.

Each of the false blisters 18a, 18b provides a degree of rigidity to the locking tail flap 14 and at the same time allows for the unfettered engagement of the locking tail flap 14 and outer shell 700. To facilitate this it is preferred, but is nevertheless optional, that the false blisters 18a, 18b are tapered or wedge-shaped or angled towards the furthermost end corners of locking tail flap 14. The angle of false blisters 18b with respect to the fold line 17 is Optionally approximately 45 degrees.

Second and third embodiments of blister strips 10 of the second invention are illustrated in FIGS. 2-11 to 2-13. In the second and third embodiments like reference numerals have been used to denote like features, albeit with the addition of ‘100’ and ‘200’ to distinguish those features as belonging to the second and third embodiments. For conciseness of description, only the differences between the embodiments of FIGS. 2-11 to 2-13 and those of FIGS. 2-1 to 2-10 will be described in greater detail.

Referring to FIG. 2-11, the free edge 120a/122/120b of the locking tail flap 114 is shaped such that the medial engaging portion 122 projects further than the wing portions 120a, 120b. The stepped formation of the free edge creates a more pronounced engaging portion 122, which may be located within the recess ‘R’ of the outer shell 700 and allows for the wing portions 120a, 120b to distort to a greater degree for fitting beneath the first auxiliary panel 710. In FIG. 2-12A, the structure of the outer shell 700, slightly in front of the recess ‘R’ is shown by a cut-away view from the outer shell 700. In this figure the internal width W700 between the side walls 725 and 715 is also illustrated. In FIG. 2-12B, a similar view of the outer shell 700 is shown. Additionally, in FIG. 2-12B, the locking tail flap 114 is shown in its locked position. It can be seen in FIG. 2-12B that the engaging portion 122 of the locking tail flap 114 is disposed within the recess ‘R’. The edge of the engaging portion 122 cannot be seen as it abuts edges of the first and second auxiliary panels 730, 740 (which edges are defined by the apertures 739, 749). The location of the wing portions 120a, 120b can also be seen. The wing portions 120a, 120b are disposed below the first auxiliary panel 730. As such, the locking tail flap 114 is securely locked and located and retained within the outer shell 700. The width W114 of the locking tail flap 114 between its side edges is sufficiently sized such that the locking tail flap can form a strut or brace between the side walls 725, 715 of the outer shell 700 for at least mitigating against, if not preventing, the locking tail flap 114 from unfolding relative to the main portion 112 of the blister strip 110. This is because there is insufficient room and the outer shell 700 cannot be distorted (by bowing the front wall 710/740/730 and bottom wall 720 away from one another) to create the headroom required.

In the third embodiment of FIG. 2-13, the free edge 220a/222/220b of the locking tail flap 214 comprises more prominent recesses 223 that optionally may be trapezoidal in shape, between the wing portions 220a, 220b and the medial engaging portion 222. The recesses 223 may serve to encourage the locking tail flap 214 to distort to a greater extent in the locked position and the tension thereby created may further tighten and strengthen the locking engagement between the locking tail flap 214 and the outer shell 700.

It can be appreciated that various changes may be made within the scope of the present invention. F or example, the size and shape of the outer shell, blister strip or inner slide card, the panels for forming the paperboard outer sleeves and the full width locking tail flaps may be adjusted to accommodate differing size and/or shape requirements. The size, shape, number and configuration of the false blisters formed on the locking tail flap 14 may be altered from that illustrated.

Whereas the illustrated embodiment comprises blisters ‘B’ integrally formed within the main body panel 12, it is envisaged that in other embodiments the article receiving blister ‘B’ may be replaced with an article receiving area to which one or more articles is affixed, for example by means of adhesive and/or wrapping film.

For example, the recesses 223 may be differently shaped and positioned; the tapered edges 24a, 24b; 124a, 124b; 224a, 224b may be omitted or, if present, differently shaped.

It will be recognized that the locking tail flaps 14, 114, 214 each may have no tapered edge portions 24a, 124a, 224a but have a uniform width all the way along its length, according to the present invention. Such an arrangement may increase the structural strength of the respective locking tail flap. Those slide cards or blister strips may be provided with tapered edge portions 28 (see FIG. 2-2) at the leading end of the blister strip 10 and may Optionally be loaded into the associated outer shell through the rear end of the outer shell before the inner and outer end closure flaps at that end are closed.

Referring now to FIGS. 3-1 through 3-11B, the third invention is described referring to some embodiments illustrated in those figures.

The present invention provides a restricted access package ‘P’ comprising a lockable receptacle (for example, a blister strip, an inner slide card, a slidable tray or box, etc.) 10 and an outer shell 700. The lockable receptacle 10 and outer shell 700 have co-operative features which can lock the lockable receptacle 10 within the outer shell 700 to thereby allow only restricted access to the receptacle 700 and its contents. Additionally, the receptacle 10 and outer shell 700 of the present invention have co-operative features to enable the receptacle 10 to be unlocked and at least partially withdrawn or slid out from the outer shell 700, so that a user may access the blisters “B” and articles held therein. In a locked configuration of the package ‘P’, the receptacle 10 is stowed within the outer shell 700 and locked in place by a mechanical complementary locking mechanism such that the articles held in the cavity or cavities “B” cannot be accessed. Operation of a release mechanism is required in order to unlock the lockable receptacle 10 from the outer shell 700 and to allow its withdrawal from the outer shell 700.

Operation of the release mechanism requires knowledge of the operation of the locking mechanism and some dexterity to operate the unlocking features and, at the same time, withdraw the lockable receptacle 10. In this way, access to the lockable receptacle 10 may be restricted to only those users of sufficient knowledge and dexterity.

As a further optional aspect of the third invention, it is envisaged that in certain embodiments, the lockable receptacle 10 and outer shell 700 may have co-operative features to prevent, restrict or otherwise mitigate against the lockable receptacle 10 being completely removed from the outer shell 700. An unlocked configuration is illustrated in FIG. 3-1, wherein the blister strip 10 is disengaged and withdrawn, albeit only to a permitted and limited extent, from the outer shell 700.

It will be understood upon reading the foregoing that the present invention provides an outer shell 700 with beneficial features and a lockable receptacle 10, 110 with beneficial features. The outer shell 700 and lockable inner receptacle 10, 110 are usable with one another and optionally, benefit may be found by utilising the lockable receptacle with its beneficial features with other outer shells or outer sleeves.

Referring now to FIG. 3-1, there is shown a perspective view of a lockable receptacle 10 in the form of a blister strip or inner slide card 10 that comprises a main strip 12. The blister strip 10 of the illustrated embodiment is a thermoformed plastic sheet (for example PVC). A main portion 12 of the blister strip 10 has at least one receiving cavity “B” for holding an article. The at least one receiving cavity “B” is formed as a protrusion of a first (upper) surface 15 and as an indentation of a second (lower) surface 27. In the illustrated arrangement of FIGS. 3-1 to 3-5, the blister strip 10 has twenty-eight blisters or cavities “B”, each for receiving an article (not shown). Optionally, the inner slide card or blister strip 10 may be lidded or sealed with a backing sheet ‘S’ such as; an aluminium foil sheet, paperboard layer, polymeric film and/or other perforable or peelable film (see FIG. 3-9). Whereas perforable films are often used in pharmaceutical push-through-packages where a tablet is pushed out of the blister “B” and this action breaks the backing film to allow that tablet to exit the blister “B”, in other embodiments, the backing film “S” may, for example, be peelable and therefore not necessarily of the push-though type. The embodiments described having punch-through backing sheets “S” are for illustrative purposes only and are not limiting.

In other envisaged embodiments, the inner slide card 10 or blister strip 10 may be formed of other suitable formable sheet material, for example other plastics or paperboard. In other arrangements, the blister strip 10 may have one or more blisters ‘B’ integrally formed therein, and may only optionally be formed by thermoforming. Alternatively or additionally, the inner slide card 10 may comprise two parts, a card type element (not shown) and a blister strip, the blister strip being attached to the card-type element such that the two parts together form a unitary element that is capable of accommodating one or more articles in individual cavities and that is capable of being withdrawn out of and pushed by relative sliding movement into an outer shell 700. The articles to be accommodated by the blisters ‘B’ of the inner slide card 10 may, for example, be tablets, pills capsules or for example any other form of medicament, healthcare item, personal item, drug, vitamin, electrical component or other article. The inner slide card 10 or blister strip 10 may be capable of holding one or more items or articles. The terms “inner slide card” and “blister strip” are used to refer to components that are placed inside the outer shell 700 and to which the blisters or cavities ‘B’ are attached or within which the blisters or cavities ‘B’ are integrally formed. The terms “inner slide card” and “blister strip” may be used to refer to components formed of paperboard, plastics material, or combinations of materials, and such components may be formed from a single piece of material or a composition of different materials.

In the illustrations accompanying the description, the blister strip 10 is shown with a series of empty blisters ‘B’. It will be understood that when reference to a package ‘P’ is made herein, it may mean a package ‘P’ containing an inner slide card 10 having or not having articles disposed and sealed within the blister cavities ‘B’.

Turning now in more detail to the structure of the blister strip 10 or inner slide card 10 shown in FIGS. 3-1 to 3-5, the inner slide card 10 comprises a main strip 12, in which article holding cavities ‘B’ are formed. In the illustrated inner slide card, twenty-four cavities ‘B’ are formed. The cavities ‘B’ project from an upper surface 15 (also referred to as “first surface”) of the main strip 12. The underside 27 (also referred to as “second surface”) of the main strip 12 can have a backing sheet attached thereto to retain and seal an article within each cavity ‘B’ once the blister strip 10 has been loaded with articles.

The leading edge 21 of the slide card 10 is the edge that first exits the outer shell 700 when the slide card 10 is withdrawn from the outer shell 700 (see FIG. 3-1). A locking tail flap 14 is formed at the opposite end of the blister strip 10 and is connected by a hinge 17 (optionally formed as a creased or demarcated or otherwise weakened fold line 17) to a trailing end of the main strip 12 of the blister strip or slide card 10 (see FIGS. 3-2-3-5). One or more integral formations 18a, 18b, each formed as a protrusion of the first surface 15 and as an indentation of the second surface 27 are provided on the locking tail flap 14. The one or more integral formations 18a, 18b each have a non-uniform height.

The one or more integral formations 18a, 18b, which may also be referred to herein as false blisters 18a, 18b, are provided on or integrally formed within the locking tail flap 14. The one or more false blisters 18a, 18b are configured such that they can each provide a degree of reinforcement or rigidity to the locking tail flap 14 to enhance its stiffness and at the same time fit within the outer shell 700 when the locking tail flap 14 is disposed in its locking position. A first portion 34 of each false blister (formation) 18a, 18b comprises a maximum height of the false blister 18a, 18b and a second portion 32 of each false blister (formation) 18a, 18b comprises a minimum height of the false blister 18a, 18b. The first portion 34 comprising the maximum height is disposed further from an engaging portion 22 of the locking tail flap 14 than the second portion 32 comprising the minimum height is. The position of the maximum height of the wedge-shaped false blister 18a, 18b is not necessarily at its end. This is because the false blisters 18a, 18b are optionally formed by moulding or thermoforming, and are rounded at their vertices and extremities.

In use, the locking tail flap 14 is folded, about hinge connection 17 towards the underside (backed) surface of the main portion 12 of the blister strip 10, and away from the blisters ‘B’. This folded configuration results in the false blisters 18a, 18b projecting above the locking tail flap 14 and between the composite front wall 730/740/710 of the outer shell 700 and the locking tail flap 14. This is best illustrated in FIG. 3-10, which shows the locked configuration of the package ‘P’.

In the illustrated embodiment, a series of further optional false blisters, ribs, or other formations 16 are provided on the main portion 12 of the blister strip 10.

The false blisters 18a, 18b, 16 are optionally press-formed or moulded out of the locking tail flap 14. Optionally, the false blisters 18a, 18b, 16 may be integrally formed with the locking tail flap 14 or affixed thereto. Where the false blisters 18a, 18b are integrally moulded out of the locking tail flap 14, the underside 27 of the locking tail flap 14 may have indentations corresponding to the impression of the false blisters 18a, 18b.

The false blisters 18a may be disposed in a series of one or more, and optionally five, substantially parallel false blisters 18a. These false blisters 18a may provide a degree of rigidity to the locking tail flap 14 and may assist in the appropriate or desired bending or flexing of the locking tail flap 14 when the locking tail flap 14 is engaged with the outer shell 700 and/or deflected to cause unlocking of the locking tail flap 14 from the outer shell 700. Optionally one or more obliquely angled false blisters 18b may be provided on the locking tail flap 14. Optionally the obliquely angled false blisters 18b may be directed towards the corners of the locking tail flap and optionally may reinforce, strengthen or otherwise enhance the rigidity of the corners of the locking tail flap 14. In the illustrated configuration, two obliquely angled false blisters 18b are provided on the locking tail flap 14, each directed from proximate the hinge connection 17 and towards a corner of the locking tail flap 14. At least one false blister 18a, 18b is optionally pressed or moulded out of the locking tail flap 14. The number, size, and configuration of the false blisters 18a, 18b provided on the locking tail flap 14 may be varied from that illustrated.

In the present arrangement, the blister strip 10 is arranged such that the locking tail flap 14 folds about hinge 17 and towards the underside 27 of the main portion 12 of the blister strip 10. This folded configuration is shown in FIG. 3-4. As a result of the locking tail flap 14 being folded relative to the main portion 12 of the blister strip 10 in this way (rather than the upper-side 15 of the locking tail flap 14 being folded towards the upper side 15 of the main portion 12 of the blister strip 10), the surface of the locking tail flap 14 that is closest to the internal locking aperture 739/749 (described below) of the outer shell or sleeve 700, is the upper-side surface 15 from which the false blisters or reinforcing ribs 18a, 18b project upwardly. The locked position of the blister strip 10 within the outer shell 700 is shown in FIG. 3-10, wherein the location of the false blisters or reinforcing ribs 18a, 18b is shown.

In FIG. 3-7 there is shown a perspective view of an optional and exemplary outer shell 700 capable of receiving the blister strip 10 for forming a package ‘P’ (see FIG. 3-1). The outer shell 700 may be formed from a variety of materials, for example, plastics material, paperboard material and/or combinations of these and other materials.

Optionally, and as illustrated, the outer shell 700 may be formed from foldable sheet material, for example paperboard. In FIG. 3-6 an exemplary embodiment of a blank 709 is illustrated. The blank 709 is for forming an exemplary outer shell 700 for use with an exemplary blister strip 10.

As illustrated, the outer shell (also referred to as a sleeve) 700 forms a generally tubular structure (see FIGS. 3-1 and 3-7) with a generally rectangular cross section. Blank 709 has a series of foldably attached panels including: a front panel 710, first side panel 715, back panel 720, second side panel 725, first auxiliary panel 730, and second auxiliary panel 740.

Front panel 710 may include a release button in the form of an area denoted by a cutline 718 which be generally U-shaped. The release button may have score lines, ribs, crease lines or other formations 719 to provide stiffness to the release button. A cut-away portion 716 may be provided which may coincide with other cut-away portions 726, 736 in the finished sleeve 700.

Back panel 720 at a “closed” end may be hingedly attached to a first or outer end closure flap 722. Back panel 720 at its opposite “open” end may be provided with an inward facing flap 724 that may be useful for retaining contents within the sleeve (for example, by its natural resilience causing the folded inward facing flap 724 to be urged towards its unfolded position in which it releasably closes the “open” end of the outer shell 700). A cutaway 726 may be provided which may coincide with other cutaways 716, 736 in the finished sleeve 700.

The first auxiliary panel 730, (which becomes an inner most ply of a composite front wall 710/740/730), comprises an aperture 739 shaped to form a recess “R” and to engage an engaging portion of the locking tail flap 14. Release tongue 738 may extend into the aperture 739 to act, along with release button 718 and a release tongue 748, in releasing the engaged part of the locking tail flap 14. At the other end of the first auxiliary panel 730 an inward facing flap 734 may be provided. The inward facing flap 734 may be useful for retaining contents within the sleeve 700, optionally by engagement of the locking tail flap 14 against an edge of that inward facing flap 734. A cutaway 736 may be provided which may coincide with other cutaways 716, 726 in the finished sleeve 700.

The second auxiliary panel 740, which becomes an intermediate-ply of the composite front wall 710/740/730, comprises an aperture 749 shaped in correspondence with and positioned in alignment with aperture 739. The aperture 749 is also arranged to form a recess “R” and to engage an engaging portion of the locking tail flap 14 of the blister strip 10. Release tongue 748 may extend into the aperture 749 to act along with release button 718 and release tongue 738 in releasing the engaged part of the locking tail flap 14. For example, the release button 718, release tongue 738, and release tongue 748 may all deflect inward when a user applies inward pressure to the release button 718. Second auxiliary panel 740 at the “closed” end may be hingedly attached to a second or inner end closure flap 742. At the opposite “open” end, cutaway 746 may be provided which may coincide with other cutaways in the finished sleeve 700. The free side edge 747 of the second auxiliary panel 740 may be shaped such that the second auxiliary panel 740 is not of a uniform width and is partially cut away.

The blank shown in FIG. 3-6 may be folded and assembled into an outer shell 700 as follows: the second auxiliary panel 740 may be folded backwards and behind the first auxiliary panel 730. The auxiliary panels 730, 740 may be attached together, for example by glue or hot melt glue. The release tongues 738, 748 generally overlap in this configuration.

The inward facing flaps 724, 734 may now be folded inward upon back panel 720 and first auxiliary panel 730 respectively. These flaps 724, 734 may be held in place by the creased fold, and/or may be glued against their respective panels, or heat sealed thereto. Preferably inward facing flap 734 is adhered to the first auxiliary panel 730 and inward facing flap 724 is not affixed to the back panel 720.

The part formed structure then may be further folded, with the auxiliary panels 730, 740 folded forward and over back panel 720. This results in a configuration where the back panel 720, second side panel 725, and auxiliary panels 730, 740 make up three walls of a tubular structure. (It should be noted that the use of tear resistant materials, and/or more than one layer, help to improve the tamper- and theft-resistance of the package.) To finish assembling the sleeve 700, the inner closure flap 742 is first folded downward. The outer closure flap 722 may then be folded upward into facing contact with the inner closure flap 742. The facing surfaces of the outer closure flap 722 and inner closure flap 742 are optionally both heat seal coated, so that a very strong seal may be created and a composite end closure wall formed at the “closed” end of the outer shell 700.

After the front panel 710 has been folded up and over secondary auxiliary panel 740, these two panels 710, 740 may be affixed together, for example by heat sealing, to form the finished sleeve 700 as shown in FIG. 3-7.

Cutaway 747 in second auxiliary panel 740 allows a portion of the inner surface of front panel 710 (a surface optionally having a heat seal coating) to seal to a portion of the surface of the first auxiliary panel 730 (a surface that may not have the heat seal coating).

As the front panel 710 is secured to both auxiliary panels 730, 740, a composite front wall is formed which has, at least in parts, three plies of material. This creates a stiff composite front wall which may help prevent bowing and enables a recess ‘R’ to be formed (see FIG. 3-10).

The outer shell 700 is configured to receive the blister strip 10 or another suitable inner slide card or blister card. As such, the composite top wall 710/740/730 and bottom wall 720 of the outer shell 700 are spaced apart and are shaped and dimensioned to create a cavity or inner housing, into which the blister strip 10 can be placed. The blister strip 10 is preferably slideably and reasonably tightly placed into the housing provided by the outer shell 700 and in such a manner that the co-operative mechanical lock, between the locking tail flap 14 and engaging apertures 739/749 is able to operate.

In FIG. 3-10 an illustration is provided of a cut-away portion of the outer-shell 700. This shows how the folded blister strip 10 fits securely within the housing provided by the outer shell 700, and how at least part of an engaging portion (also referred to as engaging edge) 22 of the locking tail flap 14 is disposed within a recess “R” formed within the three-plies of material making up the composite front wall 710/740/730 by the apertures 749 and 739 respectively. The locking tail flap 14 has a degree of natural resilience and after being folded about hinge 17, it is biased to return to its unfolded state. This degree of resilience causes at least part of the engaging portion (leading edge) 22 of the locking tail flap 14 to position itself within the recess ‘R’ and optionally abut edges of the apertures 739 and/or 749 respectively. To facilitate proper location of the engaging portion of the locking tail flap 14 within the recess ‘R’, for secure locking engagement of the blister card 10 within the outer sleeve 700, the false blisters 18a, 18b formed on the upper-side 15 of the locking tail flap 14 are shaped such that they are of a non-uniform height (see FIG. 3-8B). The angle a of the taper of the generally wedge-shaped false blister 18a, 18b may be defined as the angle between the upper surface 30 of the false blister 18a, 18b and the backing film ‘S’ on the underside of the locking tail flap 14. This angle a may optionally be between about 5° and about 20° and preferably about 15° (see FIGS. 3-9 and 3-10).

The angle a of the taper of the generally wedge-shaped false blister 18a, 18b is optionally formed generally or substantially similarly to the angle adopted by the locking tail flap 14 in its locked position (see FIG. 3-10). In this way, the top face or upper surface 30 (see FIGS. 3-8B and 3-10) of the false blister 18a may be generally aligned with or generally parallel to the composite front wall 710/740/730 of the outer shell 700 (see FIG. 3-10).

The false blisters 18a, 18b are preferably, but nevertheless optionally formed for example by thermoforming, or moulding (for example by press-moulding or blow-moulding), and as such have rounded or radiused corners (as can be seen for example in FIGS. 3-3, 3-5 and 3-8B). The length of the false blisters 18a, 18b may be between about 0.5 cm to about 2 cm. The length may be defined as the length of a base 38 of the false blister 18a, 18b between the tapered tip and the opposite end (see FIGS. 3-8B and 3-9). The obliquely angled false blisters 18b may be longer than the other false blisters 18a.

In order for each false blister 18a, 18b to provide a degree of rigidity to the locking tail flap 14 and, at the same time, allow for the unfettered engagement of the locking tail flap 14 and outer shell 700, it is preferred that a second portion 32 of the false blister 18a having the minimum height of the false blister 18a, 18b is disposed closest to the engaging portion 22 of the locking tail flap 14, compared to a first portion 34 of the false blister 18a, 18b which has the maximum height (see FIG. 3-8B). As such the false blister 18a, 18b is tapered away from the hinge connection 17 and is higher closer to the hinge connection 17 and lower further from the hinge connection 17.

An additional benefit of forming the false blister 18a, 18b such that it does not have a uniform height, and/or optionally a substantially square or rectangular form, is that the material from which the tapered false blister is formed may be thicker in parts. This is because the material will not have been stretched as much as it otherwise would have been in order to form a rectangular or square false blister having a uniform height equal to the maximum height ‘d’ of the tapered blister.

Further beneficially, the tapered, wedge-shaped and generally triangular cross-sectional shape of the false blisters 18a, 18b that are formed on the upper-side of the locking tail flap 14 may be stronger than a false blister having a square or rectangular—shaped cross-section. The false blisters 18a, 18b do not contain articles and because they are empty they may be vulnerable to being depressed or squashed. A square shaped or rectangular false blister 16 may be more easily squashed or depressed compared to a wedge-shaped false blister 18a, 18b. As such, in other envisaged embodiments, the false blisters 16 on the main portion 12 of the blister strip 10 may also be wedge-shaped or tapered. In such an arrangement, it is envisaged that the false blisters 16 would have their highest part closest to the hinge connection 17.

It can be appreciated that various changes may be made within the scope of the present invention, for example, the size and shape of the outer shell, blister strip or inner slide card, the panels for forming the paperboard outer sleeves and the structure of the false blisters may be adjusted to accommodate differing size and/or shape requirements. The size, shape, number and configuration of the false blisters formed on the locking tail flap 14 may be altered from that illustrated.

For example, the obliquely angled false blisters 18b may be omitted in embodiments where the locking tail flap 14 has a different shape. A second embodiment of the third invention is shown in FIG. 3-11A, wherein like reference numerals have been used to denote like features, albeit with the addition of ‘100’ to distinguish those features as being part of the second embodiment of the third invention. In FIG. 3-11A it can be seen that the locking tail flap 114 is slightly trapezoidal and the end most false blisters 118b in a linear series of parallel blisters 118a, 118b are not obliquely angled, but are shorter in length than the other blisters 118a.

In other envisaged embodiments, the false blisters formed on the locking tail flap may be of similar or different lengths. All the false blisters formed on the locking tail flap may be arranged in parallel alignment. In other arrangements, two or more of the false blisters formed on the locking tail flap may be in parallel alignment with each other and/or at about 90° relative to a hinge connection between the locking tail flap and the main portion of the blister strip. In some embodiments, one or more false blisters formed on the locking tail flap may not be in parallel alignment with the other false blisters. In some embodiments, one or more of the false blisters formed on the locking tail flap may be obliquely angled relative to a hinge connection between the locking tail flap and the main portion of the blister strip. In some arrangements, the false blisters formed on the locking tail flap all may have substantially the same maximum height or one or more of the false blisters formed on the locking tail flap may have a greater or lesser maximum height compared to the other false blisters.

It is further envisaged, and illustrated in FIG. 3-11B, that the top surface 230a, 230b of the false blister 218a, which may be integrally formed in a locking tail flap (not shown in FIG. 3-11B) may be discontinuous and not smooth. In such an embodiment, one or more of the integral formations may comprise two or more top surface sections 230a, 230b. In other words, the top surface may comprise a transition, such as a step, between two or more top surface sections 230a, 230b. Nevertheless, in order for the false blister 218a to provide a degree of rigidity to the locking tail flap and at the same time allow for the unfettered engagement of the locking tail flap and outer shell, it is preferred that the second portion 232 of the false blister 218a having the minimum height is disposed closest to an engaging portion of the locking tail flap compared to the first portion 234 of the false blister 218a which has the maximum height.

In other embodiments, it is further envisaged that “each” false blister comprises more than one distinctly formed portion, each of gradually greater height such that a formation may be considered as being made up of two or more “pillars”, each of different height, with the lowest pillar being disposed closest to the engaging portion of the locking tail flap. In this way an overall tapered structure may be formed that can provide a degree of rigidity to the locking tail flap and at the same time permit the unfettered engagement of the locking tail flap and the outer shell.

It can be appreciated that various changes may be made within the scope of the present inventions. For example, the size and shape of the panels and apertures may be adjusted to accommodate articles of differing size or shape. In other embodiments of the invention it is envisaged that rather than provide a plurality of empty blisters arranged in a linear series across the retention tab or main body, the retention tab or main body may comprise a single empty blister extending substantially across the primary package in a transverse direction. Optionally, the rear wall of the blister provided on the retention tab will extend linearly across the primary package, the rear wall being arranged substantially perpendicularly to a longitudinal axis (notional line D-D in FIG. 1-14 for example) of the primary package. Optionally, the front wall of the blister provided on the main body will extend linearly across the primary package, the front wall being arranged substantially perpendicularly to a longitudinal axis (notional line D-D in FIG. 1-14 for example) of the primary package.

It will be recognized that as used herein, directional references such as “top”, “bottom”, “front”, “back”, “end”, “side”, “inner”, “outer”, “upper” and “lower” do not necessarily limit the respective panels to such orientation, but may merely serve to distinguish these panels from one another.

As used herein, the terms “blister” and “cavity” have been used to describe an embossment or moulding formed in the primary package whether provided for increasing the rigidity of the primary package, or as a spacer element, or for forming a recess for receiving an item. It will be appreciated that those embossments which are provided for the function of increasing rigidity of the primary package or as a spacer element, which are also referred to herein as “false blisters” “empty cavities” or “dummy blisters”, may not be empty, or may not be configured with a recess or void; such dummy blisters may be filled with a reinforcing material or may be formed as a solid structure.

As used herein, the terms “hinged connection” and “fold line” refer to all manner of lines that define hinge features of the blank, facilitate folding portions of the blank with respect to one another, or otherwise indicate optimal panel folding locations for the blank. A fold line is typically a scored line, an embossed line, or a debossed line. The preferred form of a “hinged connection” useful with the invention is an embossed or debossed line that has been formed by a vacuum-assisted thermoforming process. Another preferred form of a “hinged connection” is a groove or rib that has been formed by stamping or cold press forming. Still another preferred form of a “hinged connection” is a linear area thinned out by stamping or thermoforming. Such a thinned out area should have a thickness less than at least the area surrounding or otherwise adjacent to the thinned out area. In short, the “hinged connection” that is useful with the invention may be defined as a living hinge that is formed simultaneously with, or at the same time with, one or more embossments located adjacent to the hinged connection and formed from the same material as that from which the one or more embossments are formed.

As used herein, the term “severance line” refers to all manner of lines that facilitate separating portions of the substrate from one another or that indicate optimal separation locations. Severance lines may be frangible or otherwise weakened lines, tear lines, cut lines, or slits.

As used herein, the word “co-formed” refers to simultaneous moulding, or otherwise forming, of two or more three-dimensional portions (e.g., debossments, embossments, blisters, cavities, projections, protrusions, grooves, ribs, recesses, openings, apertures, notches, cutouts, etc.) of a single integral member. For example, “a fold line is co-formed with a blister” means that the fold line is simultaneously moulded, or otherwise formed, together with the blister.

As used herein, the term “moulded portion” refers to a debossment, an embossment, a blister, a cavity, a projection, a protrusion, a groove, a rib, a recess, an opening, an aperture, a notch, a cutout or the like.

The preferred type of moulding used with the invention to form the hinged connections and blisters is a pressure/vacuum-assisted thermoforming and/or a plug-assisted thermoforming. The plug-assisted thermoforming may utilize either or both of stationary plugs and movable plugs.

It should be understood that hinged connection, severance lines and fold lines can each include elements that are formed in the substrate of the blank including perforations, a line of perforations, a line of short slits, a line of half-cuts, a single half-cut, a cut line, an interrupted cut line, slits, scores, any combination thereof, and the like. The elements can be dimensioned and arranged to provide the desired functionality. For example, a line of perforations can be dimensioned or designed with degrees of weakness to define a fold line and/or a severance line. The line of perforations can be designed to facilitate folding and resist breaking, to facilitate folding and facilitate breaking with more effort, or to facilitate breaking with little effort.

What is claimed is:

1. A method of manufacturing a primary package for being lockably received in an outer sleeve, the method comprising:
thermally forming at least one first embossment in a sheet of material; and
simultaneously thermally forming a fold line in the sheet of material;
wherein the primary package comprises a main body panel and a retention tab, the retention tab being hingedly connected to the main body panel along the fold line.

2. The method according to claim 1, wherein the at least one first embossment is formed in one of the main body panel and the retention tab wherein the at least one first embossment terminates at a point at a first distance from the fold line, the first distance being no greater than 2.5 mm.

3. The method according to claim 1, wherein the fold line is an embossment or debossment within the sheet of material.

4. The method according to claim 1, wherein the fold line defines an interface or demarcation between the retention tab and the main body panel.

5. The method according to claim 1, wherein the primary package comprises a first side and a second side and wherein a cover sheet is mounted upon the first side and the at least one first embossment projects from the second side, the primary package being folded such that the first side of the retention tab is folded towards the first side of the main body panel.

6. The method according to claim 5 wherein the fold line is shaped and arranged to encourage folding of the first side of the retention tab towards the first side of the main body panel.

7. The method according to claim 1, wherein the at least one first embossment extends substantially from the fold line.

8. The method according to claim 1, further comprising thermally forming at least one second embossment on the opposite side of the fold line from the at least one first embossment.

9. The method according to claim 8, wherein the at least one second embossment extends substantially from the fold line.

10. The method according to claim 8, wherein the at least one second embossment terminates at a point at a second distance from the fold line, the second distance being no greater than 2.5 mm.

11. The method according to claim 8, wherein the at least one second embossment is co-formed simultaneously with the formation of the fold line and the at least one first embossment.

12. The method according to claim 1, wherein the primary package has first and second opposed sides, and wherein the fold line comprises a ridge projecting from the first side.

13. The method according to claim 1, wherein the main body panel comprises an article receiving area, wherein the article receiving area comprises one or more cavities for receiving an item, and wherein the primary package comprises a cover sheet enclosing an article within said one or more cavities.
